(19) United States
(12) Patent Application Publication
(10) Pub. No.: US 2024/0132776 A1
(43) Pub. Date: Apr. 25, 2024

(54) SUPRAMOLECULAR CHIRALITY IN REDOX METALLOPOLYMERS

(71) Applicant: THE BOARD OF TRUSTEES OF THE UNIVERSITY OF ILLINOIS, Urbana, IL (US)

(72) Inventors: Xiao SU, Champaign, IL (US); Jemin JEON, Urbana, IL (US); Johannes ELBERT, Urbana, IL (US)

(73) Assignee: THE BOARD OF TRUSTEES OF THE UNIVERSITY OF ILLINOIS, Urbana, IL (US)

(21) Appl. No.: 18/376,348

(22) Filed: Oct. 3, 2023

Related U.S. Application Data
(60) Provisional application No. 63/413,119, filed on Oct. 4, 2022.

(51) Int. Cl. C09K 11/06

(52) U.S. Cl. CPC C09K 11/06; C09K 2211/1425; C09K 2211/187

(57) ABSTRACT

Chiral redox-polymers that have been enabled for electrochemically-controlled enantioselective interactions. Supramolecular chirality was leveraged for enhancing recognition toward target enantiomers. Chiral redox-metallopolymers were synthesized based on Ugi's amine-inspired chiral monomers, and their enantioselective recognition toward ionic enantiomers, such as tryptophan and naproxen, is demonstrated, with higher enhancement provided by a chiral redox-polymer over a single-site, chiral building block. 2D nuclear magnetic resonance spectroscopy and solid-state circular dichroism support supramolecular chirality resulting from the intramolecular interaction between the ferrocene and the alkyl group in the backbone. The chiral redox-metallopolymers can be used as a platform for electrochemically-modulated enantioselective interactions toward a range of amino acids and pharmaceutical carboxylates.

### RELATED APPLICATIONS

This application claims priority under 35 U.S.C. § 119(e) to U.S. Provisional Patent Application No. 63/413,119, filed Oct. 4, 2022, which is incorporated herein by reference.

### GOVERNMENT SUPPORT

This invention was made with government support under Grant No. 1942971 awarded by the National Science Foundation. The government has certain rights in the invention.

### BACKGROUND OF THE INVENTION

Enantioselective interactions are key to molecular diagnostics, chiral purification, asymmetric catalysis, and a central feature of enzymatic processes. The design of heterogeneous platforms for enantioselective recognition, especially through stimuli-responsive interfaces, can provide a powerful platform for chiral-based applications. Redox metallopolymers represent a distinct class of versatile functional materials and have been extensively studied for a wide scope of applications such as membranes, self-assembly, hydrogels, and redox-mediated ion separation. However, many of these studies have focused on achiral binding and release of molecules, with limited studies on chirality strategies for enantioselective interactions. Therefore, we designed a new chiral redox-polymer with chiral ferrocene (Fc) building blocks, that can serve as an electro-responsive enantioselective platform.

Ferrocene derivatives have been used as an electron-transport mediators, or as chiral selector in the homogeneous phase (Journal of the American Chemical Society 2010, 132, 8903). However, these homogeneous systems have often suffered from insufficient selectivity, the recovery of the sensor molecule, a lack of systematic signal quantification, and solubility limitations. Heterogeneous chiral systems may offer a platform for designing more efficient enantioselective interactions, especially by leveraging supramolecular chirality. Supramolecular chiral materials represent a distinct class of intricate and functional materials in chiral chemistry. They often display a higher-level chirality beyond the molecular level chirality of their building blocks. Double-stranded DNAs often consist of chiral building blocks and display a higher-level chirality beyond the molecular level chirality of their units. Thus, pathways for synthetically achieving supramolecular chirality can provide a heterogeneous platform for enantioselective recognition. Fc-derivatives have resulted in higher level chirality (Journal of the American Chemical Society 2015, 137, 7869), but the study of electrochemically mediated applications for sensing and recognition remain limited.

Accordingly, there is a need for improved methods to sense and separate chiral molecules that are mixtures of optical isomers.

### SUMMARY

The synthesis of chiral redox-metallopolymers that possess chirality at a polymer level, induced from a chiral synthesized Fc monomer, is described herein. We imparted chirality onto redox-metallopolymers through the creation of chiral-Fc-based building blocks, inspired by the well-known Ugi's amine (N,N-Dimethyl-1-ferrocenylethylamine). The corresponding polymer of these chiral redox receptors not only facilitated the fabrication of chiral electrodes by simple deposition on a current collector but also enabled supramolecular chirality, which resulted in the enhancement of their chiral resolution. The chiral Fc units in our redox-metallopolymers allowed potential-shift-based investigation on enantioselective recognition toward a wide range of chiral amino acids and carboxylates. The fabricated chiral metallopolymer electrodes can determine enantiomeric excess (% ee) over 0-100% ee L-tryptophan. Our work provides a versatile approach for the creation of enantioselective materials and demonstrates the use of the electrodes in potential-based enantioselective electrochemical sensing toward a wide range of chiral molecules.

Accordingly, this disclosure provides a chiral electrode comprising:
an optically active polymer, comprising repeating units, immobilized on a current collector, wherein one or more of the repeating units comprise a redox active moiety and an optically active moiety;
wherein at least 90% of all optically active moieties of the optically active polymer are the same optical isomer.

This disclosure further provides an optically active polymer comprising repeating units represented by formula I, II or III:

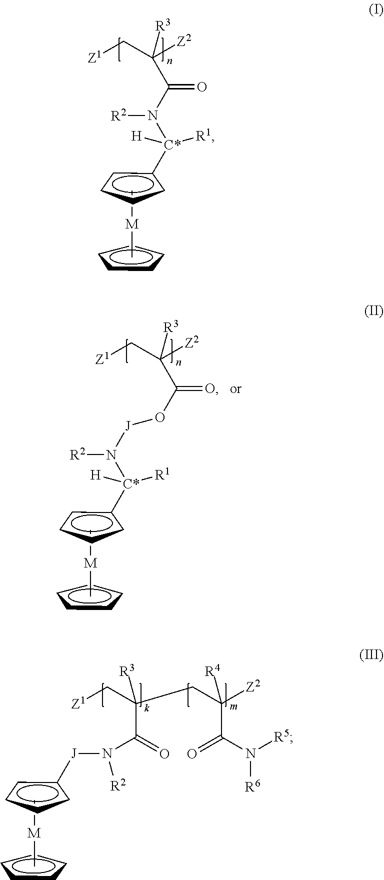

wherein, when present,
C* is a chiral carbon atom having a stereospecific configuration that is the same for at least 90% of the repeating units;
J is —(CH₂)ₓ— wherein x is 2, 3, or 4;
M is a transition metal or transition metal ion;
R¹ is alkyl;
R², R³, R⁴, and R⁵ are each independently H or alkyl;
R⁶ is an optically active moiety wherein the moiety is an amino acid, tertiary polypeptide, saccharide, or antibiotic, and at least 90% of R⁶ are the same optical isomers;
Z¹ and Z² are each independently a terminating group or a polymer block;
k and m are each independently an integer of 1-1000; and n is an integer of 10 to 1000.

In various embodiments, the optically active polymer is immobilized on a current collector.

Additionally, this disclosure also provides an electrochemical method for sensing or separating and optical isomer, comprising:
a) contacting a solution comprising a mixture of optical isomers and a chiral electrode described herein, such as the chiral electrode described above; and
b) applying a voltage potential to the chiral electrode wherein the voltage potential is applied under suitable conditions for chronoamperometry or voltammetry;
c1) sensing a preferred optical isomer in the mixture via a change in voltage, current, or impedance relative to a reference; and/or
c2) separating from the mixture the preferred optical isomer;
wherein the chiral electrode is the working electrode in an electrochemical cell and an 20 optically active moiety of the optically active polymer selectively binds to the preferred optical isomer in the mixture thereby sensing the preferred optical isomer in the mixture or separating the preferred optical isomer from the mixture.

The invention provides novel metallopolymers of formulas I-IV, intermediates for the synthesis of metallopolymers of formulas I-IV, as well as methods of preparing metallopolymers of formulas I-IV. The invention also provides metallopolymers of formulas I-IV that are useful as intermediates for the synthesis of copolymers.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1. Circular dichroism of (a) (S)-1, (R)-1, poly-(S)-1, and poly-(R)-1 with 1.0 mg/mL in THF and (b) (S)-2, (R)-2, poly-(S)-2, and poly-(R)-2 with 1.19 mg/mL in THF. Both 1 and 2 had the same molar concentration of monomer units.

FIG. 2. UV-Vis spectra of poly-(S)-1 (plain) and (S)-1 (dotted). The same solutions were used from FIG. 1.

FIGS. 3A-D. Oxidation peak current of (a) poly-(S)-1 and (b) poly-(S)-2 with different coating concentrations. Half potential shift of (c) poly-(S)-1 and (d) poly-(S)-2 after different incubation times in 30 mM D-tryptophan 1×PBS.

FIGS. 4A-F. a) Electrochemical square scheme based on chiral ferrocene (Fc) molecule binding to L enantiomer, forming two distinct electroactive species. b-c) SWV of the monomer and polymer thin film on GCE in 1×PBS at pH 6.5 (10 mM phosphate buffer in 137 mM sodium chloride, 2.7 mM potassium chloride, and 1.76 mM potassium phosphate; pH was adjusted by HCl); (b) (S)-1 and poly-(S)-1 and (c) (S)-2 and poly-(S)-2. d) Job plot of (S)-1 with deprotonated N-(tert-butoxycarbonyl)-proline (Boc-Pro), Naproxen (Nap), and N-(tert-butoxycarbonyl)-tryptophan (Boc-Trp) obtained from NMR with 5 mM of the total concentration of (S)-1 and the analytes in CD₃CN. e-f) SWV before and after binding with naproxen in 2 mM naproxen 1×PBS, showing the half potential shift (ΔE_{1/2}) of (e) poly-(S)-1 and (f) poly-(S)-2.

FIG. 5. SEM (left) and EDS mapping (carbon (middle) and iron (right)) of (a)-(c) (S)-1, (d)-(f) (S)-2, (g)-(i) poly-(S)-1, and (j)-(l) poly-(S)-2.

FIGS. 6A-F. a-b), 2D NOESY spectra of poly-(S)-1 (a) and poly-(S)-2 (b) in CDCl₃ at 500 MHz (12 scans with 300 ms mixing and 2 s delay). c-d) Solid-state CD (top) and UV absorption (bottom) spectra of (S)-1 and poly-(S)-1 (c) (S)-2 and poly-(S)-2 (d). The monomers are in dotted line and polymers in plain line. e-f) Half potential difference of (S)-1, poly-(S)-1 (e), (S)-2, and poly-(S)-2 (f) in 30 mM enantiopure tryptophan (Trp) and 2 mM enantiopure naproxen (Nap) 1×PBS at pH 6.5.

FIG. 7. Enantioselective half potential shift (ΔE_{1/2}) of the chiral redox-metallopolymers with 30 mM L-tryptophan (L-Trp; red bars) and D-tryptophan (D-Trp; black bars) in 20 mM NaClO₄. (a) poly-(S)-1, (b) poly-(R)-1, (c) poly-(S)-2, and (d) poly-(R)-2.

FIG. 8. Half potential shift (ΔE_{1/2}) and half potential shift difference (ΔΔE_{1/2}) of (a) poly-(S)-1 and (b) poly-(S)-2 with 30 mM L- and D-Trp in different electrolytes. 20 mM PBS was diluted from 1×PBS and 160 mM NaCl contained 160 mM NaCl and 3 mM KCl to have the same ionic strength as 1×PBS.

FIGS. 9A-F. Half potential shift (ΔE_{1/2}) of (a)-(b) poly-(S)-1 and (c)-(d) poly-(S)-2 in 1-30 mM of L- and D-tryptophan (Trp), 0.02-2 mM of (S)- and (R)-naproxen (Nap) enantiomers. e) Half potential shift of poly-(S)-1, poly-(S)-2, and PVF in 30 mM tryptophan in the range between enantiopure L-Trp and racemic Trp. The chiral polymers showed linear dependence over this range. f) Oxidation peaks of poly-(S)-1 in SWV at various % ee. Both half potential and oxidation potential increased toward the racemic mixture due to the stronger binding with D-Trp than with L-Trp.

FIG. 10. Theoretical and experimental half potential shift of poly-(S)-1 (a) and poly-(S)-2 (b) between 100% ee (enantiopure L-Trp) and −100% ee (enantiopure D-Trp). Theoretical values are calculated with the assumption of independent binding (dashed) and competitive binding (dash-dotted).

FIGS. 11A-D. a) Half potential difference of poly-(S)-1 and poly-(S)-2 in enantiopure 30 mM tryptophan (Trp), 2 mM naproxen (Nap), 30 mM Boc-proline (Boc-Pro), and 30 mM proline (Pro). b) Half potential shift (on left) and difference (on right) of poly-(S)-1 in 30 mM zwitterionic α-AAs and 2 mM anionic carboxylates. Phenylalanine (Phe), histidine (His), ibuprofen (Ibu), and mandelic acid (Man) were additionally used. The chemical structure of the R group of the amino acids and carboxylates are located below the figure. c) Half potential shift and shift difference of poly-(S)-1 with 2 mM naproxen in different volume fractions of MeCN in 1×PBS. d) Half potential shift difference of poly-(S)-1 and poly-(S)-2 with enantiopure 30 mM tryptophan and 2 mM naproxen at pH 5.0, 6.5, and 8.0.

FIG. 12. Half potential shift (ΔE1/2) of (a) poly-(S)-1 and (b) poly-(S)-2 with 30 mM Boc-Pro and Pro enantiomers in 1×PBS.

### DETAILED DESCRIPTION

Synthetic chiral platforms can be a powerful platform for enantioselective interactions, especially when coupled with redox-mediated electrochemical processes. While metallopolymers are versatile platforms for molecularly selective binding, their application for chiral applications is limited. In particular, the recognition and separation of biologically relevant chiral molecules can be key for biomanufacturing and diagnostics. Here, the design of chiral redox-polymers enables electrochemically controlled enantioselective interactions, and supramolecular chirality is leveraged for enhancing recognition towards target enantiomers.

Chiral redox-metallopolymers were synthesized based on Ugi's amine-inspired chiral monomers, and their enantioselective recognition toward ionic enantiomers such as tryptophan and naproxen was demonstrated, with higher enhancement provided by the chiral redox-polymer over the single-site, chiral building block itself. 2D nuclear magnetic resonance spectroscopy and solid-state circular dichroism support the emergence of supramolecular chirality resulting from the intramolecular interaction between the ferrocene and the alkyl group in the backbone. The half potential shift of the redox-polymers behaves linearly from 0% to 100% ee 1-tryptophan to enable enantiomer quantification. Investigation on solvent polarity and pH effect reveal that the enantioselective mechanism is attributed to the subtle balance between hydrogen bonding and π-π interaction.

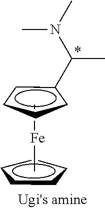

This study highlights the potential of chiral redox-metallopolymers as platforms for electrochemically modulated enantioselective interactions towards a range of amino acids and pharmaceutical carboxylates. Additional information and data supporting the invention can be found in the following publication by the inventors: Adv. Funct. Mater. 2023, 33, 2301545 and its Supporting Information, which are incorporated herein by reference in its entirety.

### Definitions

The following definitions are included to provide a clear and consistent understanding of the specification and claims. As used herein, the recited terms have the following meanings. All other terms and phrases used in this specification have their ordinary meanings as one of skill in the art would understand. Such ordinary meanings may be obtained by reference to technical dictionaries, such as Hawley's Condensed Chemical Dictionary 14^{th} Edition, by R. J. Lewis, John Wiley & Sons, New York, N.Y., 2001.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five, or one to four, for example if the phenyl ring is disubstituted.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability, necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units is also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number1” to “number2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number10”, it implies a continuous range that includes whole numbers and fractional numbers less than number10, as discussed above. Similarly, if the variable disclosed is a number greater than “number10”, it implies a continuous range that includes whole numbers and fractional numbers greater than number10. These ranges can be modified by the term “about”, whose meaning has been described above.

The recitation of a), b), c), . . . or i), ii), iii), or the like in a list of components or steps do not confer any particular order unless explicitly stated.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “contacting” refers to the act of touching, making contact, or of bringing to immediate or close proximity, including at the cellular or molecular level, for example, to bring about a physiological reaction, a chemical reaction, or a physical change, e.g., in a solution, in a reaction mixture.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation or limitations which is not specifically disclosed herein.

This disclosure provides methods of making the compounds and compositions of the invention. The compounds and compositions can be prepared by any of the applicable techniques described herein, optionally in combination with standard techniques of organic synthesis. Many techniques such as etherification and esterification are well known in the art. However, many of these techniques are elaborated in Compendium of Organic Synthetic Methods (John Wiley & Sons, New York), Vol. 1, Ian T. Harrison and Shuyen Harrison, 1971; Vol. 2, Ian T. Harrison and Shuyen Harrison, 1974; Vol. 3, Louis S. Hegedus and Leroy Wade, 1977; Vol. 4, Leroy G. Wade, Jr., 1980; Vol. 5, Leroy G. Wade, Jr., 1984; and Vol. 6; as well as standard organic reference texts such as March's Advanced Organic Chemistry: Reactions, Mechanisms, and Structure, 5th Ed., by M. B. Smith and J. March (John Wiley & Sons, New York, 2001); Comprehensive Organic Synthesis. Selectivity, Strategy & Efficiency in Modern Organic Chemistry. In 9 Volumes, Barry M. Trost, Editor-in-Chief (Pergamon Press, New York, 1993 printing); Advanced Organic Chemistry, Part B: Reactions and Synthesis, Second Edition, Cary and Sundberg (1983); for heterocyclic synthesis see Hermanson, Greg T., Bioconjugate Techniques, Third Edition, Academic Press, 2013.

The formulas and compounds described herein can be modified using protecting groups. Suitable amino and carboxy protecting groups are known to those skilled in the art (see for example, Protecting Groups in Organic Synthesis, Second Edition, Greene, T. W., and Wutz, P. G. M., John Wiley & Sons, New York, and references cited therein; Philip J. Kocienski; Protecting Groups (Georg Thieme Verlag Stuttgart, New York, 1994), and references cited therein); and Comprehensive Organic Transformations, Larock, R. C., Second Edition, John Wiley & Sons, New York (1999), and referenced cited therein.

The term “halo” or “halide” refers to fluoro, chloro, bromo, or iodo. Similarly, the term “halogen” refers to fluorine, chlorine, bromine, and iodine.

The term “alkyl” refers to a branched or unbranched hydrocarbon having, for example, from 1-20 carbon atoms, and often 1-12, 1-10, 1-8, 1-6, or 1-4 carbon atoms; or for example, a range between 1-20 carbon atoms, such as 2-6, 3-6, 2-8, or 3-8 carbon atoms. As used herein, the term “alkyl” also encompasses a “cycloalkyl”, defined below. Examples include, but are not limited to, methyl, ethyl, 1-propyl, 2-propyl (iso-propyl), 1-butyl, 2-methyl-1-propyl (isobutyl), 2-butyl (sec-butyl), 2-methyl-2-propyl (t-butyl), 1-pentyl, 2-pentyl, 3-pentyl, 2-methyl-2-butyl, 3-methyl-2-butyl, 3-methyl-1-butyl, 2-methyl-1-butyl, 1-hexyl, 2-hexyl, 3-hexyl, 2-methyl-2-pentyl, 3-methyl-2-pentyl, 4-methyl-2-pentyl, 3-methyl-3-pentyl, 2-methyl-3-pentyl, 2,3-dimethyl-2-butyl, 3,3-dimethyl-2-butyl, hexyl, octyl, decyl, dodecyl, and the like. The alkyl can be unsubstituted or substituted, for example, with a substituent described below or otherwise described herein. The alkyl can also be optionally partially or fully unsaturated. As such, the recitation of an alkyl group can include an alkenyl group or an alkynyl group. The alkyl can be a monovalent hydrocarbon radical, as described and exemplified above, or it can be a divalent hydrocarbon radical (i.e., an alkylene).

An alkylene is an alkyl group having two free valences at a carbon atom or two different carbon atoms of a carbon chain. Similarly, alkenylene and alkynylene are respectively an alkene and an alkyne having two free valences at a carbon atom or two different carbon atoms.

The term “cycloalkyl” refers to cyclic alkyl groups of, for example, from 3 to 10 carbon atoms having a single cyclic ring or multiple condensed rings. Cycloalkyl groups include, by way of example, single ring structures such as cyclopropyl, cyclobutyl, cyclopentyl, cyclooctyl, and the like, or multiple ring structures such as adamantyl, and the like. The cycloalkyl can be unsubstituted or substituted. The cycloalkyl group can be monovalent or divalent, and can be optionally substituted as described for alkyl groups. The cycloalkyl group can optionally include one or more cites of unsaturation, for example, the cycloalkyl group can include one or more carbon-carbon double bonds, such as, for example, 1-cyclopent-1-enyl, 1-cyclopent-2-enyl, 1-cyclopent-3-enyl, cyclohexyl, 1-cyclohex-1-enyl, 1-cyclohex-2-enyl, 1-cyclohex-3-enyl, and the like.

The term “heteroatom” refers to any atom in the periodic table that is not carbon or hydrogen. Typically, a heteroatom is O, S, N, P. The heteroatom may also be a halogen, metal or metalloid.

The term “heterocycloalkyl” or “heterocyclyl” refers to a saturated or partially saturated monocyclic, bicyclic, or polycyclic ring containing at least one heteroatom selected from nitrogen, sulfur, oxygen, preferably from 1 to 3 heteroatoms in at least one ring. Each ring is preferably from 3- to 10-membered, more preferably 4 to 7 membered. Examples of suitable heterocycloalkyl substituents include pyrrolidyl, tetrahydrofuryl, tetrahydrothiofuranyl, piperidyl, piperazyl, tetrahydropyranyl, morpholino, 1,3-diazapane, 1,4-diazapane, 1,4-oxazepane, and 1,4-oxathiapane. The group may be a terminal group or a bridging group.

The term “aromatic” refers to either an aryl or heteroaryl group or substituent described herein. Additionally, an aromatic moiety may be a bisaromatic moiety, a trisaromatic moiety, and so on. A bisaromatic moiety has a single bond between two aromatic moieties such as, but not limited to, biphenyl, or bipyridine. Similarly, a trisaromatic moiety has a single bond between each aromatic moiety.

The term “aryl” refers to an aromatic hydrocarbon group derived from the removal of at least one hydrogen atom from a single carbon atom of a parent aromatic ring system. The radical attachment site can be at a saturated or unsaturated carbon atom of the parent ring system. The aryl group can have from 6 to 30 carbon atoms, for example, about 6-10 carbon atoms. The aryl group can have a single ring (e.g., phenyl) or multiple condensed (fused) rings, wherein at least one ring is aromatic (e.g., naphthyl, dihydrophenanthrenyl, fluorenyl, or anthryl). Typical aryl groups include, but are not limited to, radicals derived from benzene, naphthalene, anthracene, biphenyl, and the like. The aryl can be unsubstituted or optionally substituted with a substituent described below. For example, a phenyl moiety or group may be substituted with one or more substituents R^{X} where R^{X} is at the ortho-, meta-, or para-position, and X is an integer variable of 1 to 5.

The term “heteroaryl” refers to a monocyclic, bicyclic, or tricyclic ring system containing one, two, or three aromatic rings and containing at least one nitrogen, oxygen, or sulfur atom in an aromatic ring. The heteroaryl can be unsubstituted or substituted, for example, with one or more, and in particular one to three, substituents, as described in the definition of “substituted”. Typical heteroaryl groups contain 2-20 carbon atoms in the ring skeleton in addition to the one or more heteroatoms, wherein the ring skeleton comprises a 5-membered ring, a 6-membered ring, two 5-membered rings, two 6-membered rings, or a 5-membered ring fused to a 6-membered ring.

Examples of heteroaryl groups include, but are not limited to, 2H-pyrrolyl, 3H-indolyl, 4H-quinolizinyl, acridinyl, benzo[b]thienyl, benzothiazolyl, β-carbolinyl, carbazolyl, chromenyl, cinnolinyl, dibenzo[b,d]furanyl, furazanyl, furyl, imidazolyl, imidizolyl, indazolyl, indolisinyl, indolyl, isobenzofuranyl, isoindolyl, isoquinolyl, isothiazolyl, isoxazolyl, naphthyridinyl, oxazolyl, perimidinyl, phenanthridinyl, phenanthrolinyl, phenarsazinyl, phenazinyl, phenothiazinyl, phenoxathiinyl, phenoxazinyl, phthalazinyl, pteridinyl, purinyl, pyranyl, pyrazinyl, pyrazolyl, pyridazinyl, pyridyl, pyrimidinyl, pyrrolyl, quinazolinyl, quinolyl, quinoxalinyl, thiadiazolyl, thianthrenyl, thiazolyl, thienyl, triazolyl, tetrazolyl, and xanthenyl. In one embodiment the term “heteroaryl” denotes a monocyclic aromatic ring containing five or six ring atoms containing carbon and 1, 2, 3, or 4 heteroatoms independently selected from non-peroxide oxygen, sulfur, and N(Z) wherein Z is absent or is H, O, alkyl, aryl, or (C₁-C₆)alkylaryl. In some embodiments, heteroaryl denotes an ortho-fused bicyclic heterocycle of about eight to ten ring atoms derived therefrom, particularly a benz-derivative or one derived by fusing a propylene, trimethylene, or tetramethylene diradical thereto.

As used herein, the term “substituted” or “substituent” is intended to indicate that one or more (for example, in various embodiments, 1-10; in other embodiments, 1-6; in some embodiments 1, 2, 3, 4, or 5; in certain embodiments, 1, 2, or 3; and in other embodiments, 1 or 2) hydrogens on the group indicated in the expression using “substituted” (or “substituent”) is replaced with a selection from the indicated group(s), or with a suitable group known to those of skill in the art, provided that the indicated atom's normal valency is not exceeded, and that the substitution results in a stable compound. Suitable indicated groups include, e.g., alkyl, alkenyl, alkynyl, alkoxy, haloalkyl, hydroxyalkyl, aryl, heteroaryl, heterocyclyl, cycloalkyl, alkanoyl, alkoxycarbonyl, amino, alkylamino, dialkylamino, carboxyalkyl, alkylthio, alkylsulfinyl, and alkylsulfonyl.

Stereochemical definitions and conventions used herein generally follow S. P. Parker, Ed., McGraw-Hill Dictionary of Chemical Terms (1984) McGraw-Hill Book Company, New York; and Eliel, E. and Wilen, S., “Stereochemistry of Organic Compounds”, John Wiley & Sons, Inc., New York, 1994. The compounds of the invention may contain asymmetric or chiral centers, and therefore exist in different stereoisomeric forms. It is intended that all stereoisomeric forms of the compounds of the invention, including but not limited to, diastereomers, enantiomers and atropisomers, as well as mixtures thereof, such as racemic mixtures, which form part of the present invention. Many organic compounds exist in optically active forms, i.e., they have the ability to rotate the plane of plane-polarized light. In describing an optically active compound, the prefixes D and L, or R and S. are used to denote the absolute configuration of the molecule about its chiral center(s). The prefixes d and l or (+) and (−) are employed to designate the sign of rotation of plane-polarized light by the compound, with (−) or 1 meaning that the compound is levorotatory. A compound prefixed with (+) or d is dextrorotatory. For a given chemical structure, these stereoisomers are identical except that they are mirror images of one another. A specific stereoisomer may also be referred to as an enantiomer, and a mixture of such isomers is often called an enantiomeric mixture. A 50:50 mixture of enantiomers is referred to as a racemic mixture or a racemate (defined below), which may occur where there has been no stereoselection or stereospecificity in a chemical reaction or process.

The terms “racemic mixture” and “racemate” refer to an equimolar mixture of two enantiomeric species, devoid of optical activity.

The term “enantiomerically enriched” (“ee”) as used herein refers to mixtures that have one enantiomer present to a greater extent than another. Reactions that provide one enantiomer present to a greater extent than another would therefore be “enantioselective” (or demonstrate “enantioselectivity”). In one embodiment, the term “enantiomerically enriched” refers to a mixture having at least about 2% ee; in another embodiment of the invention, the term “enantiomerically enriched” refers to a mixture having at least about 5% ee; in another embodiment of the invention, the term “enantiomerically enriched” refers to a mixture having at least about 20%; in another embodiment of the invention, the term “enantiomerically enriched” refers to a mixture having at least about 50%; in another embodiment of the invention, the term “enantiomerically enriched” refers to a mixture having at least about 80%; in another embodiment of the invention, the term “enantiomerically enriched” refers to a mixture having at least about 90%; in another embodiment of the invention, the term “enantiomerically enriched” refers to a mixture having at least about 95%; in another embodiment of the invention, the term “enantiomerically enriched” refers to a mixture having at least about 98%; in another embodiment of the invention, the term “enantiomerically enriched” refers to a mixture having at least about 99%. The term “enantiomerically enriched” includes enantiomerically pure compositions that are mixtures that are substantially free of the species of the opposite optical activity or one enantiomer is present in very low quantities, for example, less than about 0.01%, 0.001% or 0.0001%.

A “solvent” as described herein can include water or an organic solvent. Examples of organic solvents include hydrocarbons such as toluene, xylene, hexane, and heptane; chlorinated solvents such as methylene chloride, chloroform, and dichloroethane; ethers such as diethyl ether, tetrahydrofuran, and dibutyl ether; ketones such as acetone and 2-butanone; esters such as ethyl acetate and butyl acetate; nitriles such as acetonitrile; alcohols such as methanol, ethanol, and tert-butanol; and aprotic polar solvents such as N,N-dimethylformamide (DMF), N,N-dimethylacetamide (DMA), and dimethyl sulfoxide (DMSO). Solvents may be used alone or two or more of them may be mixed for use to provide a “solvent system”.

The term, “tertiary polypeptide”, refers to a protein having chirality and optical activity or a chain of peptides having a number of monomers (e.g., at least about 6, 8, 10, 12, or 15) sufficient to form a three-dimensional configuration that displays chirality and optical activity, for example a left- or right-handed helix formed by the polypeptide.

The term “saccharide” refers to a monosaccharide, an oligosaccharide, or a polysaccharide. The term “oligosaccharide” refers to a linear, branched, or cyclic chain of monosaccharide units that has 4 to about 10 monosaccharide units. A polysaccharide therefore refers to a linear, branched, or cyclic chain of monosaccharide units that has 11 or more monosaccharide units.

The term, “chiral electrode”, herein refers to an electrode that comprises an optically active substance such as an optically active polymer.

The term, “repeat unit”, “repeating unit”, or “block” as used herein refers to the moiety of a polymer that is repetitive. The repeat unit may comprise one or more repeat units, labeled as, for example, repeat unit A, repeat unit B, repeat unit C, etc. Repeat units A-C, for example, may be covalently bound together to form a combined repeat unit. Monomers or a combination of one or more different monomers can be combined to form a (combined) repeat unit of a polymer or copolymer.

The term “molecular weight” for the copolymers disclosed herein refers to the average number molecular weight (Mₙ). The corresponding weight average molecular weight (M_{w}) can be determined from other disclosed parameters by methods (e.g., by calculation) known to the skilled artisan.

The term “current collector” refers to a metal, such as a foil made nickel or copper, that collects electrons from and transports them to a circuit. An electrode of an electrochemical battery includes the current collector and an electrode active material layer coated on a surface of the current collector.

The copolymers disclosed herein can comprise random or block copolymers. The copolymers of formula III described herein can be a random copolymer, as shown by the “f” over the bond between the k and m units of the copolymer.

In various embodiments, the ends (Z¹, Z², or unlabeled) of the polymer (i.e., the initiator end or terminal end) can be a low molecular weight moiety (e.g. under 500 Da), such as, H, OH, OOH, CH₂OH, CN, NH₂, or a hydrocarbon such as an alkyl (for example, a butyl or 2-cyanoprop-2-yl moiety at the initiator and terminal end), alkene or alkyne, or a moiety as a result of an elimination reaction at the first and/or last repeat unit in the copolymer, or as specified otherwise.

### Embodiments of the Technology

This disclosure provides an optically active polymer comprising repeating units represented by formula I, II or III:

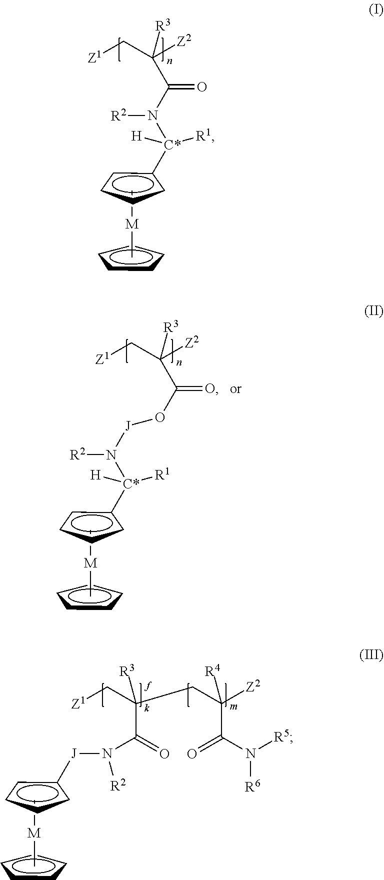

wherein, when present,
f indicates the polymer is a random copolymer or a block copolymer;
C* is a chiral carbon atom having a stereospecific configuration that is the same for at least 90% of the repeating units;
J is —(CH₂)ₓ— wherein x is 1, 2, 3, or 4;
M is a transition metal or transition metal ion;
R¹ is alkyl;
R², R³, R⁴, and R⁵ are each independently H or alkyl;
R⁶ is an optically active moiety wherein the moiety is an amino acid, a tertiary polypeptide, a saccharide (e.g., a monosaccharide, or an oligosaccharide or polysaccharide, straight chain, branched, or cyclic), or an antibiotic, and at least 90% of R⁶ are the same optical isomers (or have the same direction of optical rotation);
Z¹ and Z² are each independently a terminating group or a polymer block;
k and m are each independently an integer from 1-100 or 1-1000; and n is an integer from 10 to 1000.

In various embodiments, each alkyl moiety is independently —(C₁-C₁₂)alkyl, methyl, ethyl, propyl, butyl, pentyl, hexyl, heptyl, octyl, nonyl, decyl, undecyl, or dodecyl, wherein each alkyl is unbranched or branched. In various embodiments, k, m, and n are each independently an integer from 1-10, 2-10, 1-25, 2-25, 25-50, 50-75, 75-100, 100-150, 150-200, 200-250, 250-500, 500-750, 750-1000, 1000-1500, or 1500-2000. In some embodiments, when Z¹ and Z² are polymer blocks, each are independently poly(benzyl methacrylate), polystyrene or poly(2,3,4,5,6-pentafluorobenzyl methacrylate), wherein the number of repeating unit an integer from 1-100 or 1-1000

In some embodiments, the transition metal or transition metal ion is iron, cobalt, titanium, vanadium, manganese, nickel, chromium, or zinc. In some embodiments, the optically active moiety is an amino acid such as alanine, valine, isoleucine, leucine, methionine, phenylalanine, tyrosine, tryptophan, serine, threonine, asparagine, glutamine, cysteine, selenocysteine, glycine, proline, arginine, histidine, lysine, aspartic acid, glutamic acid, and derivatives thereof (many of which are commercially available). For example, Boc(tert-butyloxycarbonyl)-protected amino acids, methyl-ester-protected amino acids, Fmoc(fluorenylmethoxycarbonyl)-protected amino acids.

In some embodiments, the optically active moiety is mono-, di-, tri-, or oligosaccharides of fructose, galactose, glucose, ribose, and deoxyribose. In some embodiments, the optically active moiety is an glycopeptide antibiotic such as teicoplanin, teicoplanin aglycone, vancomycin, vancomycin aglycone, oritavancin, telavancin, ristocetin, ristocetin A, or dalbavancin. In some embodiments, the optically active moiety is a polypeptide such as Substance P, Glucagon, Neuropeptide Y, Enkephalin, or Calcitonin. Such derivatives can be prepared by one of ordinary skill in the art following the general procedures described by Hermanson, G. T. “Bioconjugate Techniques”, Academic Press., 3^{rd} ed., 2013.

Additionally, this disclosure provides an optically active polymer comprising pyranose repeating units represented by formula IV:

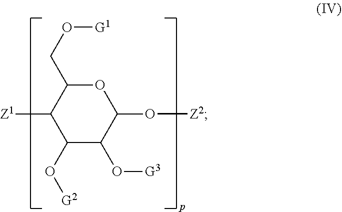

wherein
G¹, G², or G³ are each independently —(C═O)Mc, —(C═O)alkyl, or H;
Mc is:

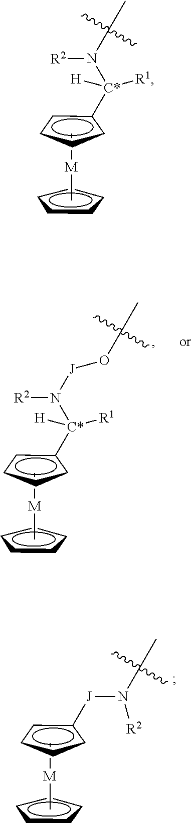

and the other variables are as defined above.

Other embodiments of this technology include various polymers wherein one or more of the repeating units of the polymer comprises the group Mc.

The variable Mc is shown to have a metallocene that is directly bonded to a chiral carbon atom (C*), in which case Mc is both the redox active moiety and the optically active moiety. When the metallocene is not bonded directly to a chiral center, such as C*, but instead bonded to a non-chiral moiety, such as variable J, then the redox moiety is not the optically active moiety. In this case, the optically active moiety is remote to the redox moiety at a substituent position elsewhere on the backbone of the optically active polymer. Whether the metallocene is or is not an optically active moiety, it can undergo reduction and oxidation (redox) under suitable reduction and oxidation conditions.

In various embodiments the pyranose repeating unit shown in formula IV is a repeating unit of allose, altrose, glucose, mannose, gulose, iodose, galactose, or talose. In various embodiments the pyranose repeating units are mono-, di-, tri-, or oligosaccharides of allose, altrose, glucose, mannose, gulose, iodose, galactose, talose, or a combination thereof.

In some embodiments, Z¹ and/or Z² are:

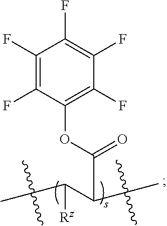

wherein R^{z} is H or alkyl; and s is 1, 2, or 3.

In various embodiments, the transition metal is iron or an iron ion. In various embodiments, the optically active polymer is represented by formula I. In various embodiments, the optically active polymer is poly(N-1-ferrocenyl ethylmethacrylamide).

In various embodiments, the optically active polymer is represented by formula II. In various embodiments, the optically active polymer is 2-((1-ferrocenylethyl)(methyl)amino) ethyl methacrylate.

In various embodiments, the chiral carbon atom (C*) has an (S)-configuration. In various embodiments, the chiral carbon atom (C*) has an (R)-configuration.

In various embodiments, the optically active polymer is represented by formula III. In various embodiments, the optical rotation of R⁶ is levorotatory. In various embodiments, the optical rotation of R⁶ is dextrorotatory.

The polymers described herein may be thermally or photochemically crosslinked by a crosslinker. The crosslinker is a highly reactive intermediate that forms either by heating or by UV radiation. In various embodiments, the optically active polymer is crosslinked by the crosslinker or is a block of a copolymer. In various embodiments, crosslinkers are benzendisulfonyl azide, benzophenones, anthraquinones, azido-methyl-coumarins, diazirines, and psoralens. In some embodiments, a crosslinker is covalently bonded to one polymer moiety at R¹, R², R³, R⁴, R⁵, or R⁶ and to another polymer moiety at R¹, R², R³, R⁴, R⁵, or R⁶. Examples of crosslinking and mechanisms of crosslinking are detailed in Macromolecules 2008, 41, 23, 9284-9289.

This disclosure also provides a chiral electrode comprising an optically active polymer described herein, wherein the optically active polymer is immobilized on a current collector. Current collectors can be prepared by coating a solution comprising the polymer onto a current collector. Current collectors comprise a piece of electrically conductive materials such as stainless steel, carbon, titanium, or copper. A solution comprising an optically active polymer can be prepared by dispersing or dissolving the polymer in solvents such as acetonitrile, chloroform, dichloromethane, dimethylformamide, dimethylacetamide, dimethyl sulfoxide, or tetrahydrofuran. The coating solution is then coated onto the conductive material. Coating techniques include dip coating, spin coating, spray coating, drop-casting, and by using doctor blade to apply the coating.

In various embodiments, the chiral electrode further comprises carbon, such as mesoporous carbon, a carbon allotrope, or carbon nanotube, that is immobilized on the chiral electrode, wherein the carbon is dispersed together with an optically active polymer onto the electrode. In some embodiments the optically active polymer is:

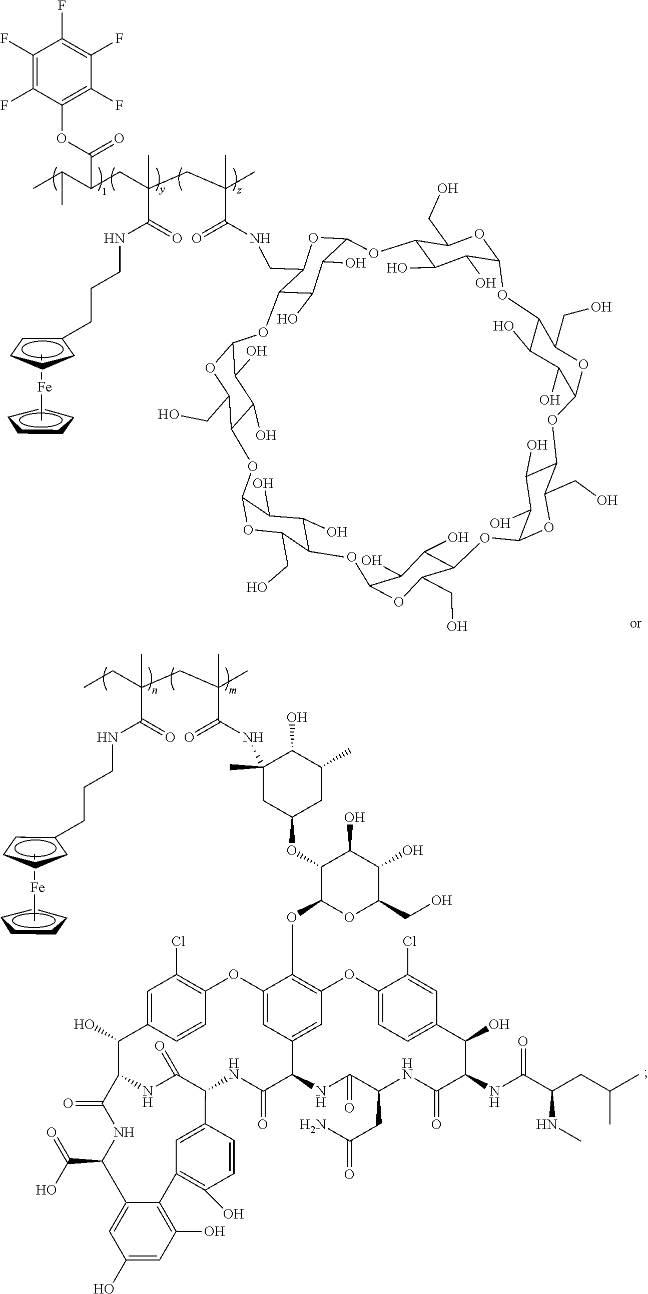

wherein,
m is an integer from 1-100 or 1-1000;
n is an integer from 10 to 1000;
y is an integer from 10 to 1000; and
z is an integer from 1-100 or 1-1000.

In some embodiments, m, n, x, and y are each independently an integer from 1-10, 2-10, 1-25, 2-25, 25-50, 50-75, 75-100, 100-150, 150-200, 200-250, 250-500, 500-750, 750-1000, 1000-1500, or 1500-2000.

Furthermore, this disclosure provides a chiral electrode comprising:
an optically active polymer, comprising repeating units, immobilized on a current collector, wherein one or more of the repeating units comprise a redox active moiety and an optically active moiety;
wherein at least 90% of all optically active moieties of the optically active polymer are the same optical isomer.

In various embodiments, the redox active moiety is a metallocene. In various embodiments, wherein the redox active moiety is the optically active moiety. In various embodiments, the redox active moiety is a metallocene comprising an amino group or nitrogen atom covalently bonded to a chiral carbon atom. In various embodiments, the redox active moiety is 1-ferrocenylethylamino.

In various embodiments, the optically active moiety comprises one or more chiral centers. In various embodiments, the optically active moiety comprises nitrogen atom covalently bonded directly to a chiral carbon atom. In various embodiments, the optically active moiety is bonded directly or indirectly to the metallocene. In various embodiments, the optically active moiety is an amino acid, tertiary polypeptide, monosaccharide, oligosaccharide, polysaccharide, or antibiotic.

When present, a polypeptide, oligosaccharide, or polysaccharide can be straight chain, branched, or cyclic. In some embodiments, the antibiotic, for example, is penicillin, vancomycin, erythromycin, streptomycin, rifampicin, or tetracycline, wherein said antibiotics are chiral and have optical activity.

In various embodiments, the repeating unit comprises an acrylate that forms the backbone of the optically active polymer. In various embodiments, the repeating unit is N-1-ferrocenyl ethylmethacrylamide or 2-((1-ferrocenylethyl)(methyl)amino)ethyl methacrylate. In various embodiments, the optically active polymer is poly(N-1-ferrocenyl ethylmethacrylamide) or poly(2-((1-ferrocenylethyl)(methyl)amino)ethyl methacrylate).

In various embodiments, the optically active polymer comprises about 10 to about 1000 repeating units. In various embodiments, the number of repeat units that the optically active polymer comprises is about 10 to about 20, 20 to about 40, 40 to about 50, 50 to about 75, 75 to about 100, 100 to about 150, 150 to about 200, 200 to about 300, 300 to about 400, 400 to about 500, 500 to about 750, or 750 to about 1000.

This disclosure additionally provides an electrochemical method comprising:
a) contacting a solution comprising a mixture of optical isomers and a chiral electrode described herein; and
b) applying a voltage potential to the chiral electrode wherein the voltage potential is applied under suitable conditions for chronoamperometry or voltammetry;
c1) sensing a preferred optical isomer in the mixture via a change in voltage, current, or impedance relative to a reference; and/or
c2) separating from the mixture the preferred optical isomer;
wherein the chiral electrode is the working electrode in an electrochemical cell and an optically active moiety of the optically active polymer selectively binds to the preferred optical isomer in the mixture thereby sensing the preferred optical isomer in the mixture or separating the preferred optical isomer from the mixture.

In various embodiments, the applied voltage potential is sufficient to oxidize or reduce the optically active polymer. In various embodiments, the applied voltage potential is applied across a voltage range that is sufficient to oxidize or reduce the optically active polymer. In various embodiments, the solution is a supersaturated mixture of optical isomers.

In various embodiments, the method further comprises inducing nucleation and crystallization of the preferred optical isomer on the chiral electrode. In various embodiments, the method further comprises desorbing the preferred optical isomer to provide a separated optical isomer that is optically active.

### Results and Discussion

Design, synthesis, and characterization. Here, we design and synthesize two chiral redox-metallopolymers containing an amide (poly-1) or tertiary amine group (poly-2) in the position of the amine of Ugi's amine (Scheme 1). The building block of the two chiral redox-metallopolymers was inspired by Ugi's amine, a commercially available Fc derivative with a tertiary amine, methyl group, and cyclopentadienyl rings of Fc around the chiral center. These functional groups can provide various donor-acceptor type interactions for enantioselective recognition. The enantioselective recognition of Ugi's amine was evaluated by measuring its half potential shift (ΔE_{1/2}) upon the addition of 10 equivalent tryptophan enantiomers. The opposite affinity of Ugi's amine enantiomers toward the enantiomers was observed as the half potential of (S)- and (R)-Ugi's amine shifted −77 mV and −67 mV with L-tryptophan, and −62 mV and −90 mV with D-tryptophan, respectively.

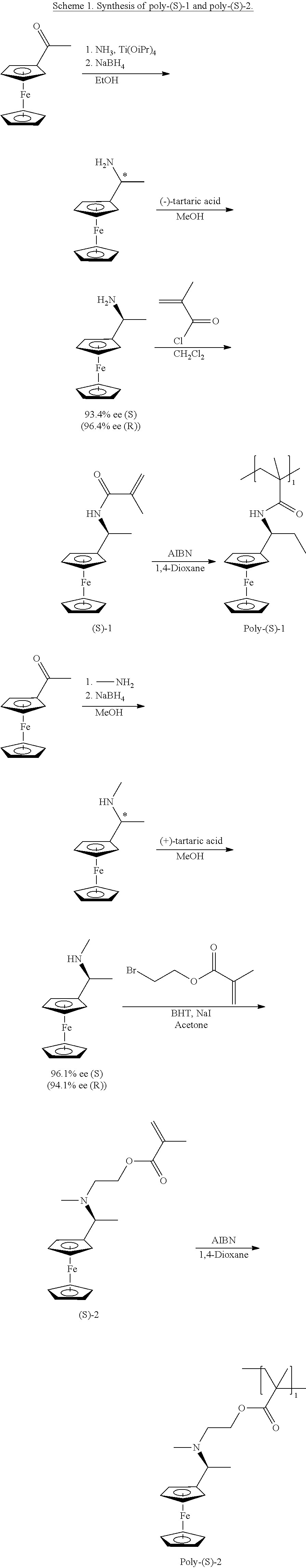

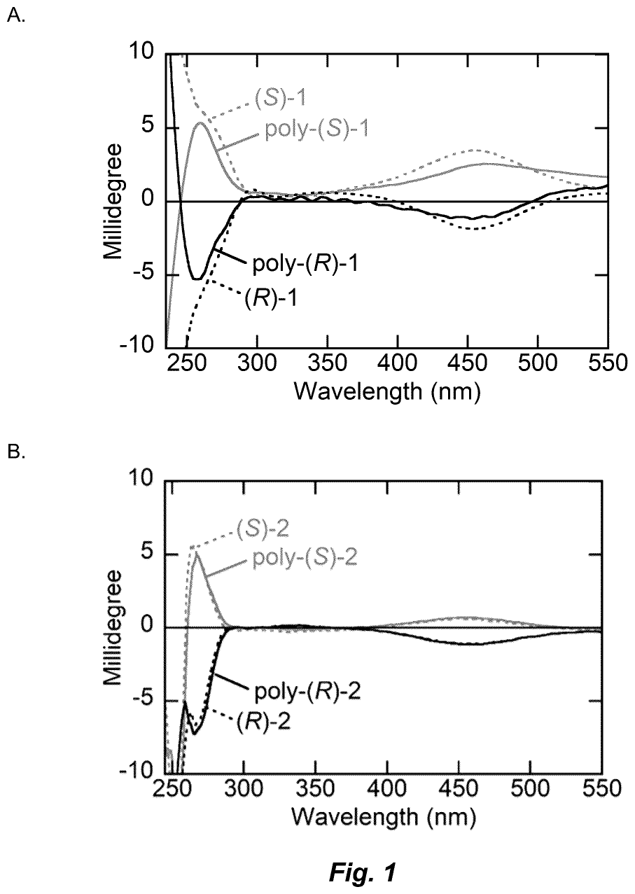

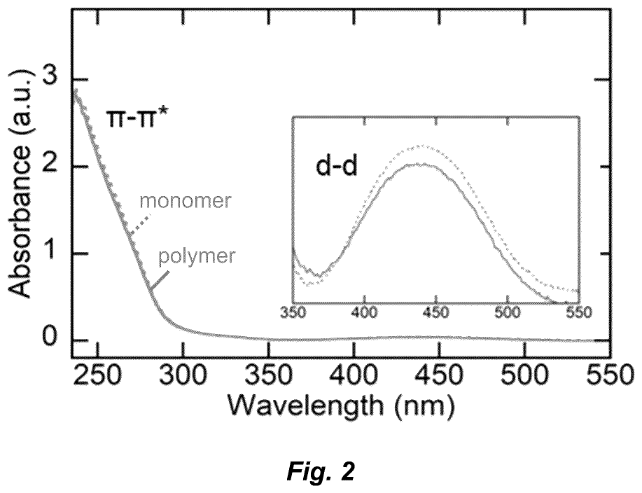

For the synthesis of N-(1-ferrocenylethyl) methacrylamide ((S)- and (R)-1), the racemic 1-ferrocenyl-ethylamine was prepared by reductive amination with ammonia and the enantiomers were separated by diastereomeric with (+)-tartaric acid yielding 96.4% ee (R) and (−)-tartaric acid 93.4% ee (S) according to the high-pressure liquid chromatography (HPLC). Consecutively, the amide monomers (S)- and (R)-1 were prepared by reaction of the corresponding amines with methacryloyl chloride. For 2-((1-ferrocenylethyl)(methyl)amino) ethyl methacrylate ((S)- and (R)-2), the racemic N-methyl-1-ferrocenyl-ethylamine after the reductive amination of acetylferrocene with methylamine were separated by the same crystallization method yielding 96.1% ee (S) and 94.7% ee (R), followed by the addition of 2-bromoethyl methacrylate to prepare (S)- and (R)-2. Single-crystal X-ray diffraction revealed the absolute chirality of (s)-1 and (S)-N-methyl-1-ferrocenyl-ethylamine NMR, mass spectrometry, and CHN elemental analysis were used to confirm the molecular structures of the products in each step. (S)-1, (R)-1, (S)-2, and (R)-2 were polymerized by free radical polymerization into poly-(S)-1 (M_{w}=8650), poly-(R)-1 (M_{w}=26400), poly-(S)-2 (M_{w}=11400), and poly-(R)-2 (M_{w}=20800), and ¹H NMR and GPC confirmed their structures and molecular weights. Circular dichroism (CD) revealed the opposite chirality of the monomers and polymers for both 1 and 2 (FIG. 1). The Cotton effects observed in the two absorption spectra of π-π* (250 nm) and d-d (450 nm) regions (UV-Vis in FIG. 2) were attributed mainly to the Fc located right next to the chiral center.

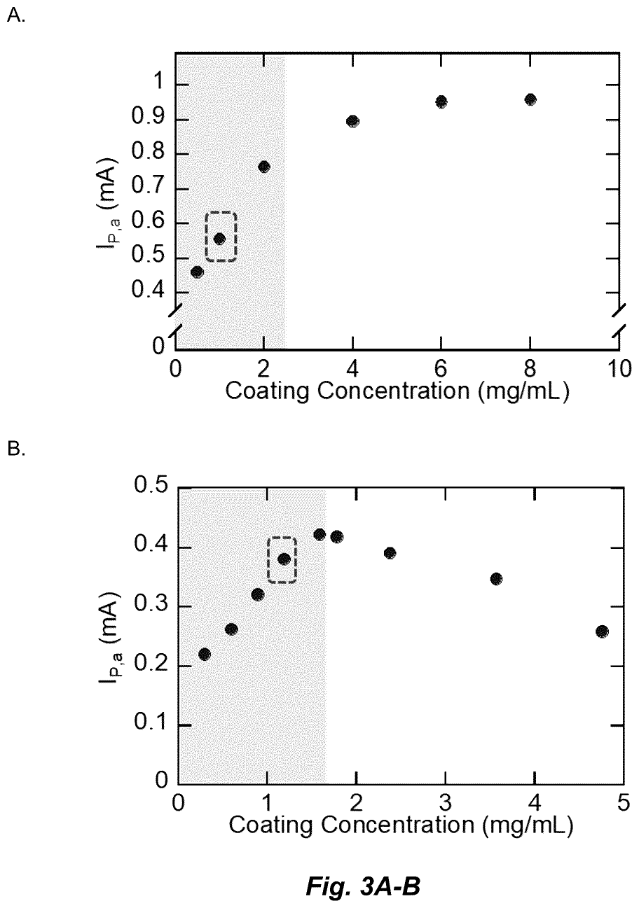

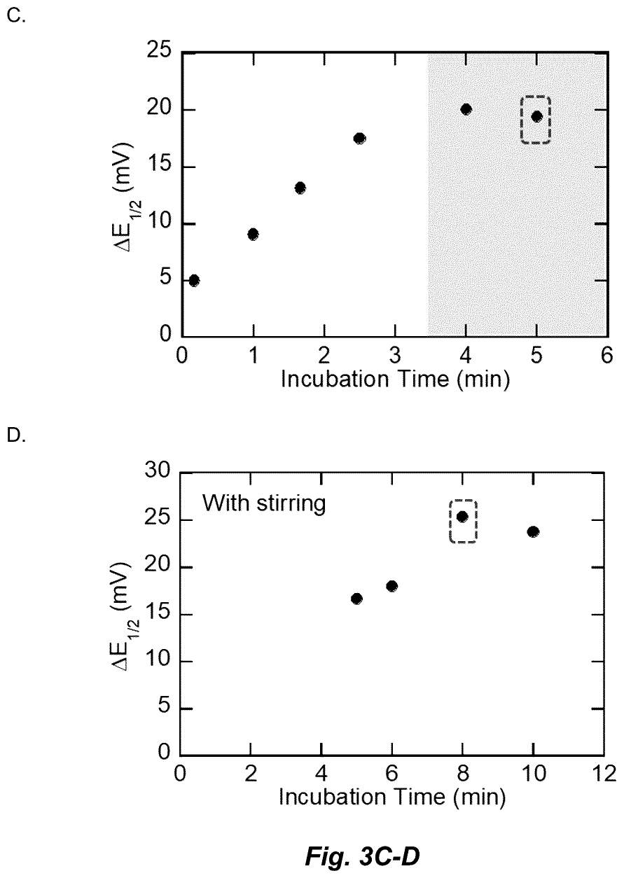

Chiral redox electrodes were fabricated by drop-casting a polymer solution in chloroform on a glassy carbon electrode (GCE) chloroform. The concentration of the polymers was varied to find the range of an optimal concentration which can circumvent high charge-transfer and diffusion resistance of excess polymer film deposition and was set to 1 mg/mL for poly-(S/R)-1 and 1.19 mg/mL for poly-(S/R)-2 (FIGS. 3A-B). The film thickness of poly-(S)-1 was 62 nm near the edge of a glassy carbon substrate and 170 nm at the center based on surface profilometry and 3D laser scanning confocal microscope. The observed linear relationship between the peak current and the square root of the voltammetry scan rate described the redox reaction of the polymer film was diffusion controlled. The incubation time in an analyte solution was set to 8 min under stirring to reach equilibrium in the analyte binding process (FIGS. 3C-D).

Mechanism for chiral redox-metallopolymer interaction with target enantiomers. Within the current work, redox peak potential shift of the Fc moiety upon complexation with chiral molecules was utilized as means to probe enantioselective interaction. Previously in electrochemical enantioselective recognition, ferrocene (Fc)-derivatives have been used as an electron-transport mediator and binder without participating in the recognition of an analyte. Peak potential shifts of a host or guest chiral molecule can sense enantioselective interactions and therefore have been used in potential-dependent enantioselective recognitions (Sensors and Actuators B: Chemical 2020, 319, 128315).

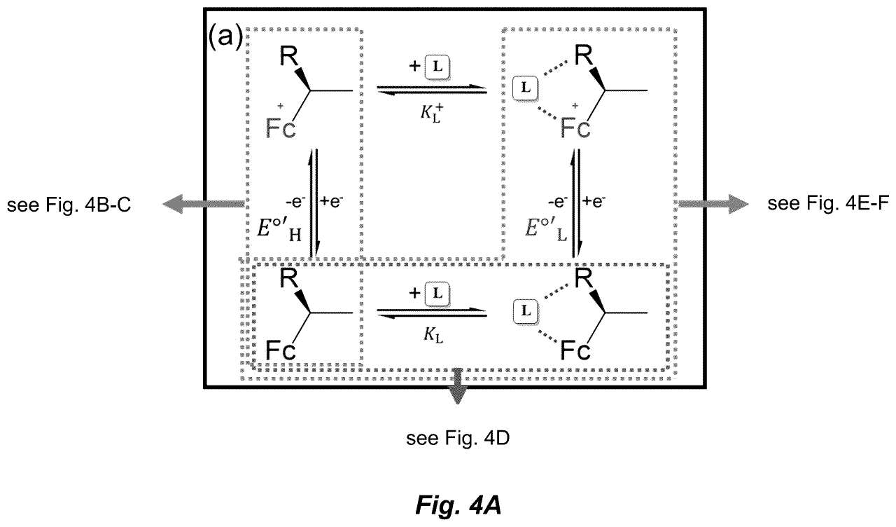

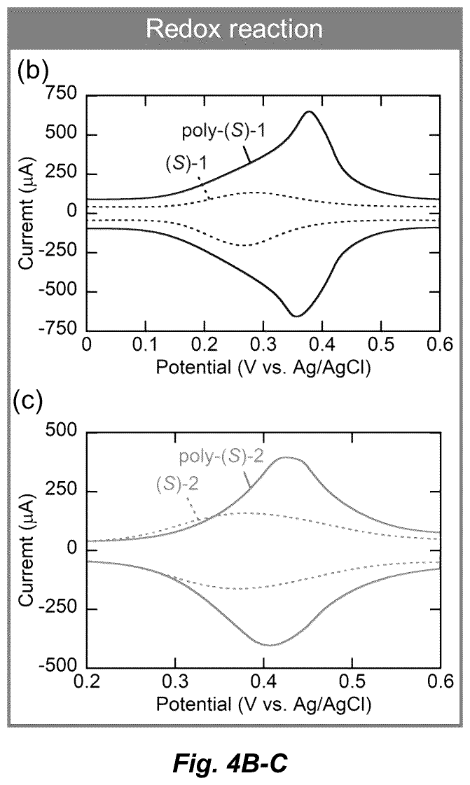

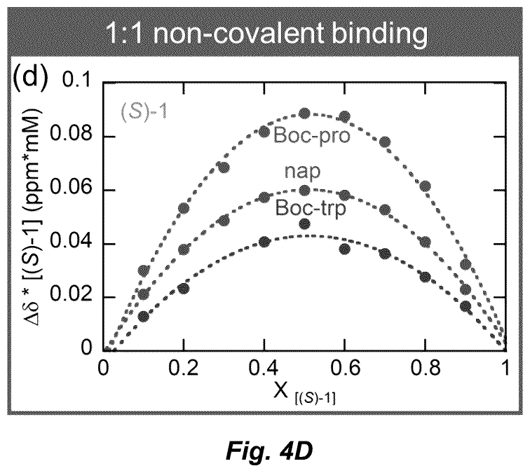

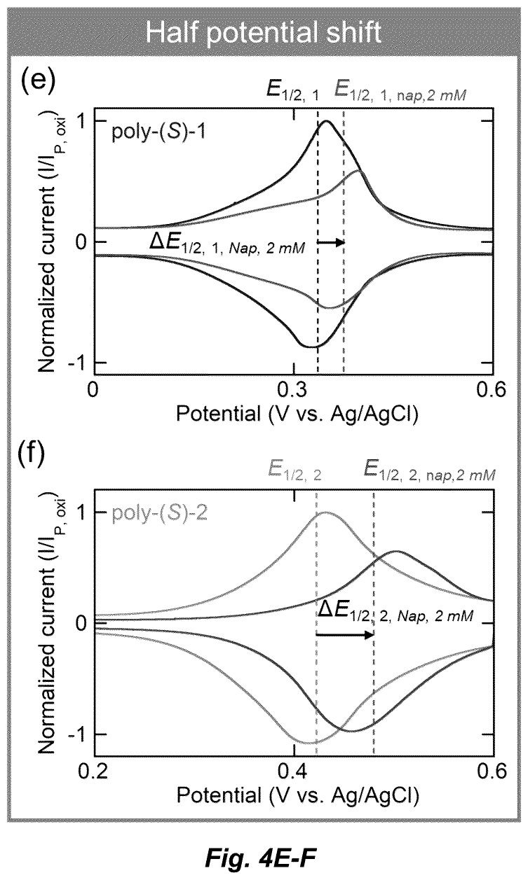

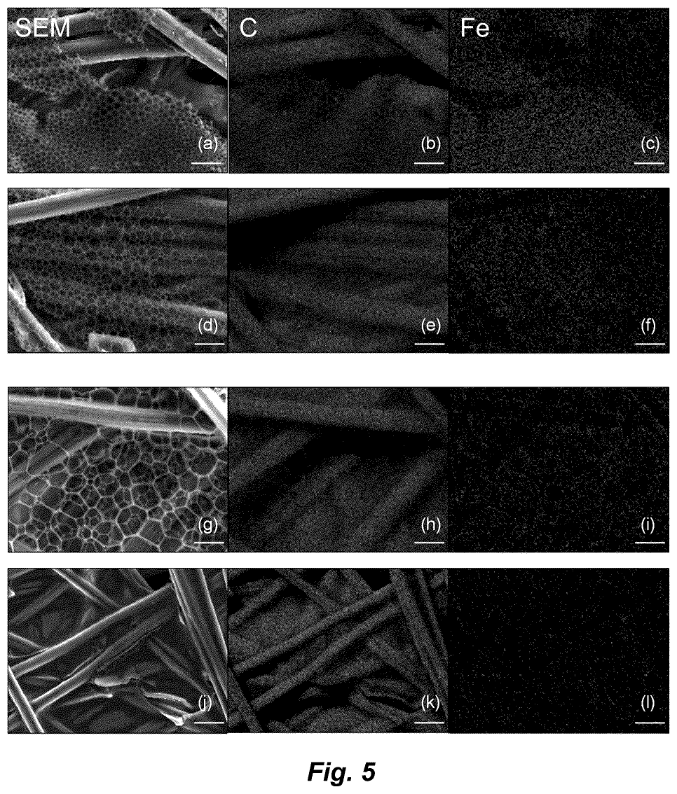

The illustrative scheme in FIG. 4A provides the pathways for possible electrochemical and non-electrochemical binding of the chiral Fc-units with L enantiomer. Square wave voltammetry (SWV) of (S)-1, poly-(S)-1, (S)-2, and poly-(S)-2 deposited on GCE demonstrated that the redox reaction occurred at the half potential of 272, 369, 412, and 419 mV vs. Ag/AgCl, respectively (FIGS. 4B and 4C). The half potential of poly-(S)-2 was 50 mV higher than poly-(S)-1 due to its tertiary amine which is more electron-withdrawing for the Fc than the amide of poly-(S)-1. The high peak currents of the polymers (630 μA and 420 μA with poly-(S)-1 and poly-(S)-2) compared to those of the monomers (130 μA and 160 μA with (S)-1 and (S)-2) were attributed to their porous structure (SEM in FIG. 5). A Job plot of (S)-1 in a homogeneous acetonitrile (MeCN) solution obtained by NMR revealed the 1:1 binding between the chiral Fc unit and chiral analytes (N-(tert-butoxycarbonyl)-proline (Boc-proline), naproxen, and N-(tert-butoxycarbonyl)-tryptophan (Boc-tryptophan) (FIG. 4D). The chemical structures of the analytes used in this study are listed in Chart 1.

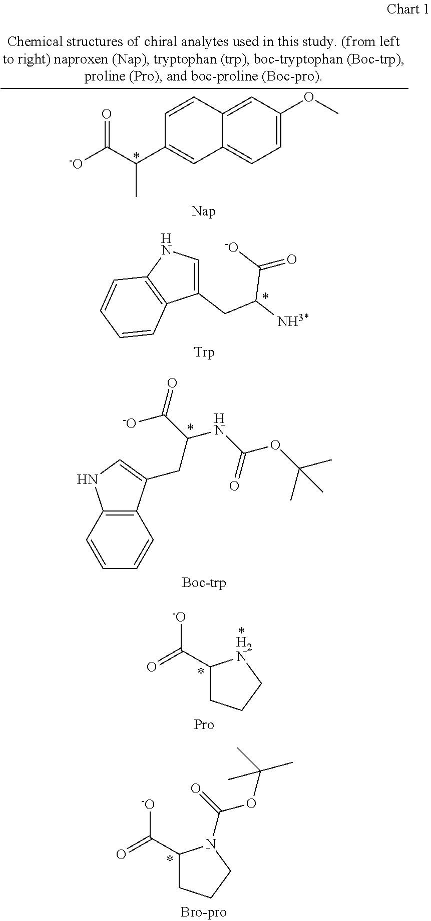

FIGS. 4E and 4F show the half potential shift (ΔE_{1/2})of poly-(S)-1 and poly-(S)-2 in the presence of 2 mM (S)-naproxen in phosphate buffer saline at pH6.5 (1×PBS; 10 mM phosphate buffer in 137 mM sodium chloride (NaCl), 2.7 mM potassium chloride (KCl), and 1.76 mM potassium phosphate). The half potential shift of poly-(S)-2 (56 mV) was 1.7 times higher than that of poly-(S)-1 (33 mV) likely because the protonated amine led to a stronger electrostatic interaction with the anionic naproxen (K_{Nap,2}>K_{Nap,1}). The peak current after the analyte binding decreased by 40%, due to the slower electron transfer of the Fc in the complex than the free Fc. The current decrease of an Fc receptor upon analyte binding was also previously reported (Analytical Chemistry 2021, 93, 10160).

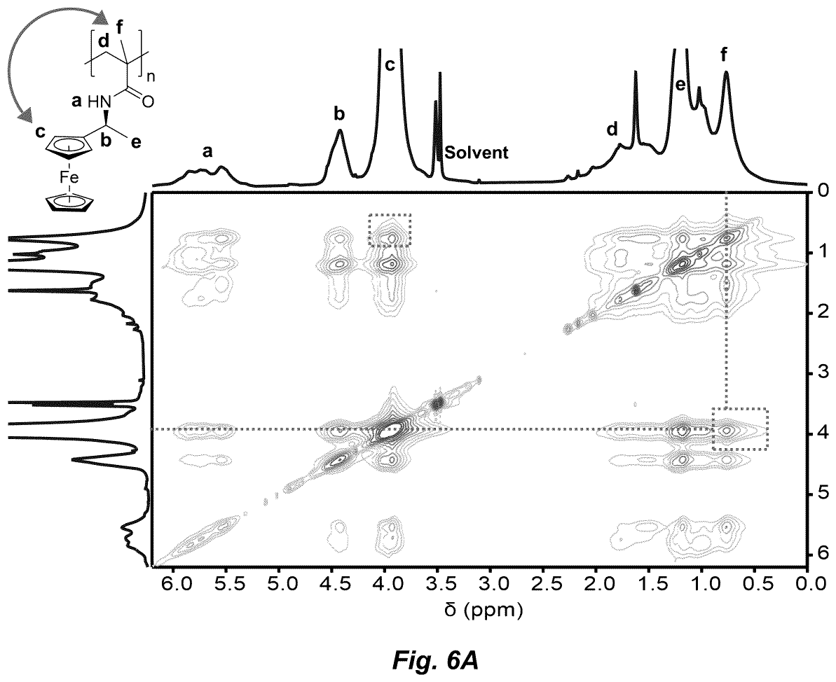

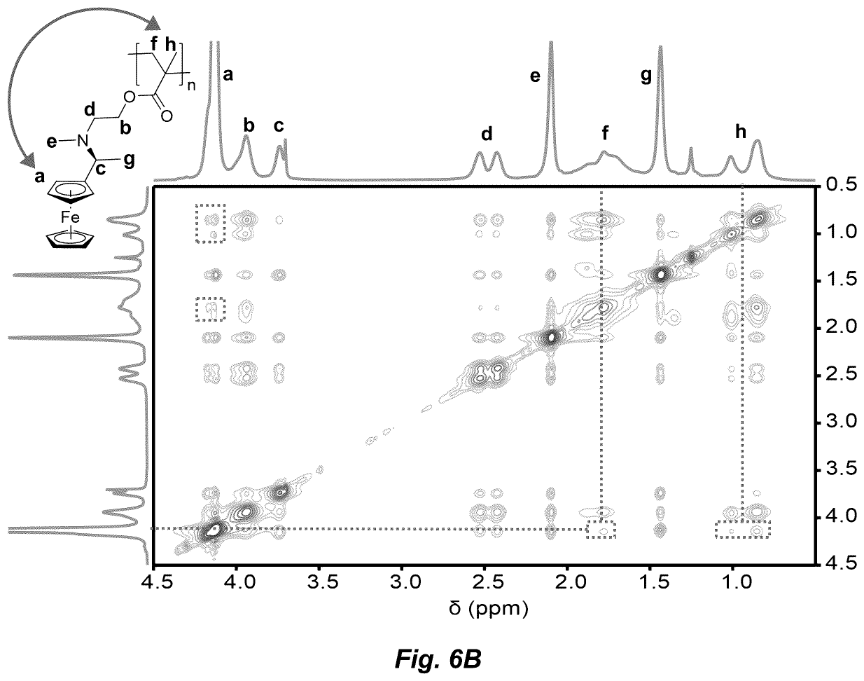

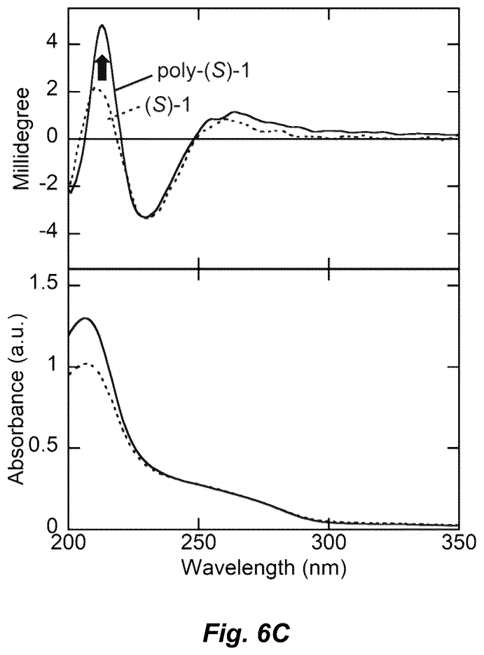

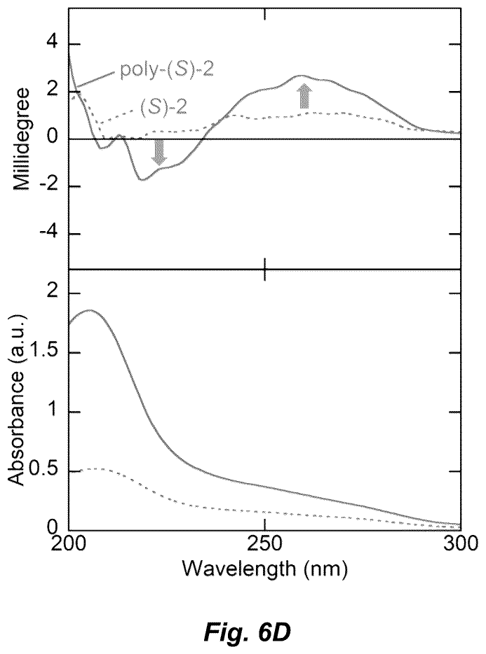

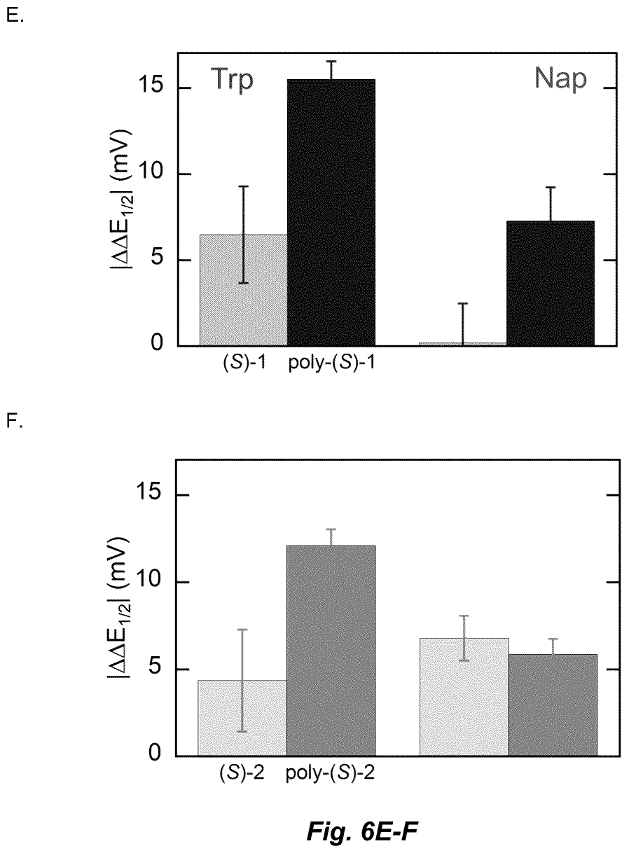

Supramolecular Chirality within the Redox-polymers and Enhancement in Enantioselective Recognition. 2D NMR and solid-state CD of poly-(S)-1 and poly-(S)-2 revealed their supramolecular chirality induced by the point chirality in their monomer units, which enhanced the enantioselective recognition of the polymers compared to their monomers. The intensities of CD spectra of the monomers and polymers with the same chirality had no noticeable difference in solution (i.e., tetrahydrofuran and chloroform), indicating that their optical activity was derived from the point chirality (FIG. 1). However, an intramolecular interaction between the Fc and the backbone of both polymers was detected based on Nuclear Overhauser Effect Spectroscopy (2D NOESY) NMR. Poly-(S)-1 presented cross-peaks of protons in the Fc (c) with protons in CH₂ (d) and CH₃ (f) in the backbone, while poly-(S)-2 also showed cross-peaks of protons in the Fc (a) with protons in CH₂ (f) and CH₃ (h) in the backbone (FIGS. 6A and 6B). In contrast, the Fc moiety of the monomers had cross-peaks only with neighboring protons within two carbon chains; the intramolecular interaction was not shown in the 2D NOESY of the corresponding monomers.

The solid-state CD and UV-Vis spectra of the polymers and monomers deposited on a quartz substrate showed an intensity increase in both polymers owing to the induced supramolecular chirality (FIGS. 6C and 6D). The chirality transfer from the monomer building block to a longer scale in the backbone was attributed to the intramolecular interaction between the Fc and the alkyl group in the backbone of the polymers and the steric hindrance of the Fc leading to the rigidity of the polymers. A bulky Fc closely located to a backbone or a reactive site is reported to exert the steric hindrance giving stiffness to a macromolecule or a decrease in reactivity. Powder XRD of poly-(S)-1 and poly-(S)-2 gave the d-spacing value of 5.76 and 5.79 Å, which indicated a constant distance between neighboring Fc's in the polymers.

We then compared the half potential shift difference (|ΔΔE_{1/2}|) of poly-(S)-1, poly-(S)-2, and their corresponding monomers with tryptophan or naproxen. The enantioselective resolution of the polymers increased compared to that of their monomers (FIGS. 6E and 6F). With 30 mM tryptophan, poly-(S)-1 and poly-(S)-2 showed |ΔΔE_{1/2}| of 15.5 and 12.1 mV that were noticeably higher than those of the corresponding monomers (6.5 and 4.4 mV, respectively). With 2 mM naproxen, poly-(S)-1 had 7.3 mV of |ΔΔE1/2| while (S)-1 showed a negligible ΔΔE_{1/2} (0.2 mV), implying that the size of a binding pocket controlled by the induced supramolecular chirality played a key role to the selectivity. However, poly-(S)-2 and (S)-2 had a similar selectivity toward naproxen enantiomers (6.8 and 5.9 mV) because the larger pocket from the long alkyl chain between the Fc and the backbone of poly-(S)-2 gave less conformational constraint than that of poly-(S)-1. Powder XRD of (S)-1 showed crystallinity which was attributed to the hydrogen bonding (HB) intermolecular interaction between the amide groups of (S)-1 according to ATR-IR, which may hamper the enantioselective recognition of the (S)-1 electrode. The discrepancy between the half potentials of (S)-1 (270 mV) and poly-(S)-1 (370 mV) in FIG. 4B also explained the less electron-withdrawing property of the amide of (S)-1 because of the HB the amide participated in.

In summary, the supramolecular chirality of the chiral redox-metallopolymers was observed by the solid-state dichroism and this supramolecular chirality could be a primary factor leading to the enhancement in their enantioselective resolution. The conformational constraints originated from the size of the binding pocket formed by the intramolecular interactions of the polymers (FIGS. 6A and 6B) and intermolecular interaction between the monomers could further affected the enantioselective resolution difference between the polymers and their monomers.

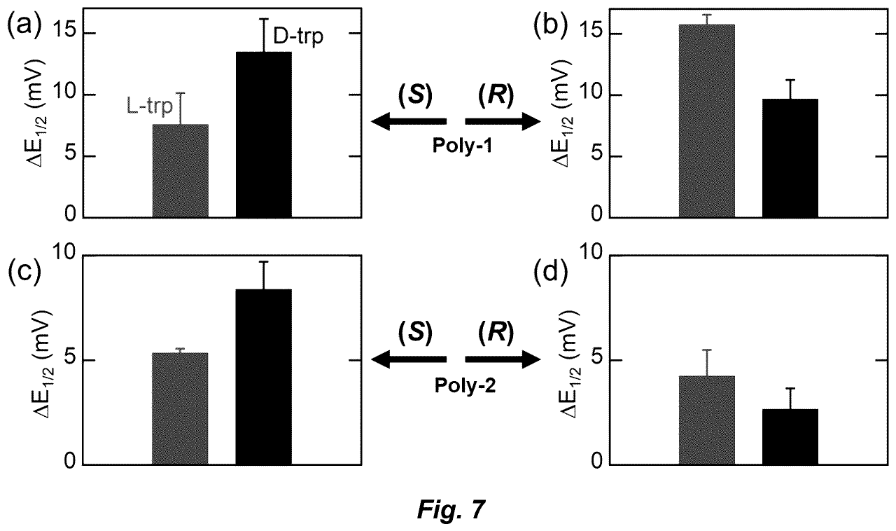

Enantioselective Potential Shift of the Chiral Redox-metallopolymers with Tryptophan. We investigated the redox-mediated enantioselective interaction of the chiral redox-metallopolymers and their corresponding monomers with tryptophan (FIGS. 7A-7D). The half potential shift of both poly-(S)-1 and poly-(S)-increased more with increasing D-tryptophan concentration (13.5 and 8.4 mV) than the opposite enantiomer, L-tryptophan (7.6 and 5.4 mV), while the half potential of poly-(R)-1 and poly-(R)-2 shifted more with L-tryptophan (15.8 and 4.2 mV) than with D-tryptophan (9.7 and 2.7 mV), proving the enantioselective interaction of both redox-metallopolymers (FIGS. 7A and 7C).

The asymmetry between the potential shifts of (S) and (R) was attributed to the different enantiopurity of the monomers as (R)-1 (96.4% ee) and (S)-2 (96.1% ee) had higher enantiopurity than (s)-1 (93.4% ee) and (R)-2 (94.1% ee), respectively. As a result, poly-(R)-1 and poly-(S)-2 had the higher shift difference (|ΔΔE_{1/2}|) (6.1 and 3 mV) than poly-(S)-1 and poly-(R)-2 (5.9 and 1.5 mV), respectively. The monomer-coated electrodes were also fabricated and tested with the same method and parameters as the polymer electrodes, showing the same potential shift trend toward the tryptophan enantiomers as the polymer-coated electrodes. For the comparison between the enantioselective recognition of the amide- and amine-functionalized polymers, their (5) forms and corresponding monomers were used in the rest of the study.

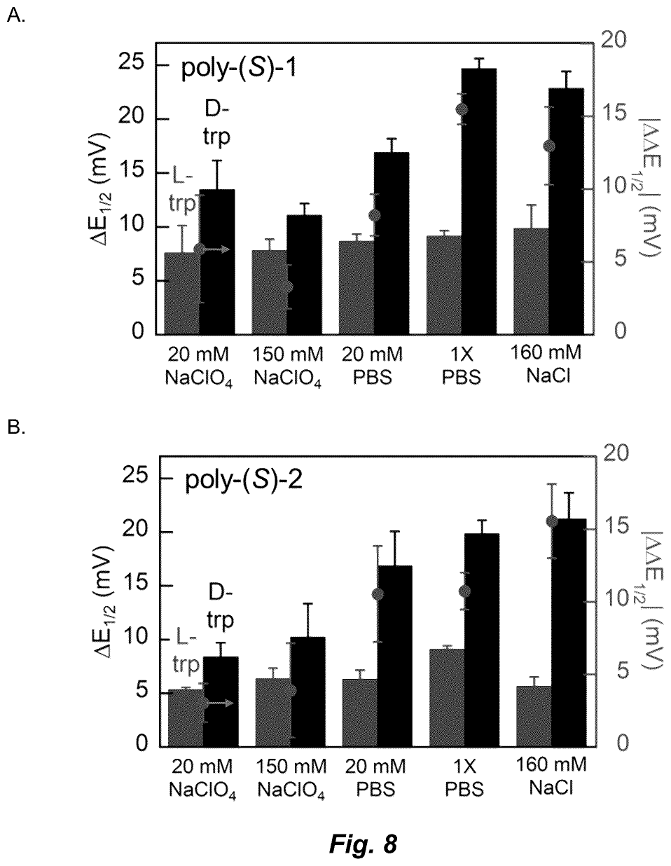

Next, the nature of the supporting electrolytes and ionic strength were varied to study their effect on the half potential shift of poly-(S)-1 and poly-(S)-2 (FIGS. 8A and 8B). In addition to NaClO₄, 1×PBS at pH 6.5 was chosen to investigate the applicability of our chiral redox-polymers in biologically relevant model mixtures. In 150 mM NaClO₄, the change of the half potential shift (ΔE_{1/2}) and the half potential shift difference (|ΔΔE_{1/2}|) of both polymers was marginal within 2.6 mV compared to the values in 20 mM NaClO₄. The marginal half potential change was ascribed to the stable ion-paring between a perchlorate anion and an Fc⁺. The stable ion-paring between a perchlorate anion and an Fc⁺ has been reported (Chemical and Pharmaceutical Bulletin 2001, 49, 818).

In 20 mM PBS and 1×PBS, both the half potential shift and the half potential shift difference of the polymers were higher than in the NaClO₄ media. Especially, the half potential shift difference in 1×PBS was 4.7 times higher for poly-(S)-1 (15.5 mV) and 2.8 times higher for poly-(S)-2 (10.8 mV) than in 150 mM NaClO₄ (3.3 and 3.9 mV). Given that both electrolytes have similar ionic strength (150 mM for NaClO₄, 163 mM for 1×PBS), this shift difference was attributed to the difference of the competing anions, ClO₄⁻ and Cl⁻, making the PBS biological medium suitable for the potential use of the chiral electrodes in sensing. Furthermore, the increase in the half potential shift difference in 1×PBS compared to 20 mM PBS (8.2 mV for poly-(S)-1 and 10.6 mV for poly-(S)-2) explains that the film swelling helped the enantioselective interaction of the polymers in the PBS medium.

Lastly, an electrolyte without phosphate showed a decrease in the half potential shift difference of poly-(S)-1 by 2.5 mV. In contrast, the half potential shift difference of poly-(S)-2 increased by 4.8 mV owing to the absence of the phosphate which can electrostatically bind to the amine of poly-(S)-2. The binding between phosphate and amine, which has been previously studied in literature (J. Amer. Chem. Soc. 2003, 125, 14807), could potentially hamper the enantioselective binding between tryptophan and the monomer unit. There was no effect of pH on the potential shifts as the pH values of the electrolytes were close to each other between 6.1-6.5 and showed no significant change after the experiment.

Analyte-concentration-dependent Potential Shift of the Chiral Redox-metallopolymers. The half potential shift of poly-(S)-1 and poly-(S)-2 was measured in the presence of varying concentrations of tryptophan or naproxen enantiomers, to evaluate the enantioselective recognition of each chiral redox-metallopolymers against the target analytes. The concentration range was 0.02-2 mM for naproxen and 1-30 mM for tryptophan based on the solubility of each analyte in 1×PBS and potential resolution of the SWV method (0.1 mV). The potential window of SWV was set to 0.0-0.6 V to avoid the interference on the polymer potential shift by the redox activity of tryptophan and naproxen which of the redox potential is above the window.

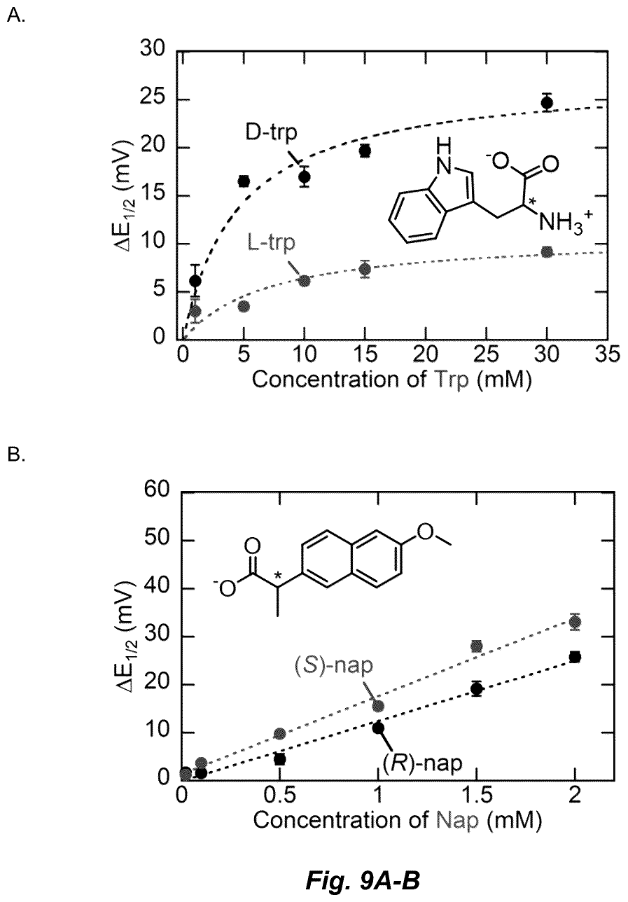

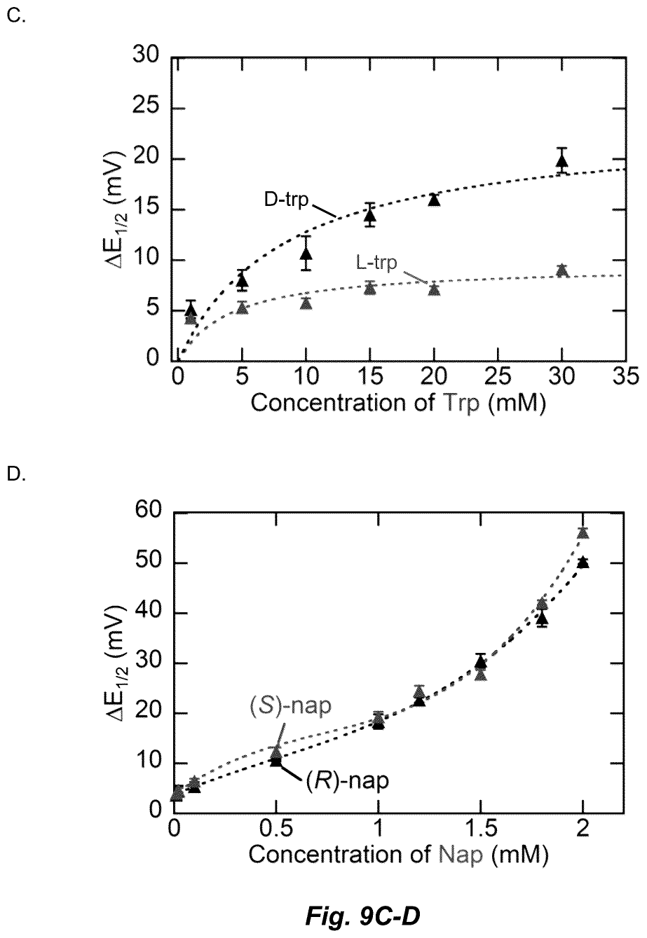

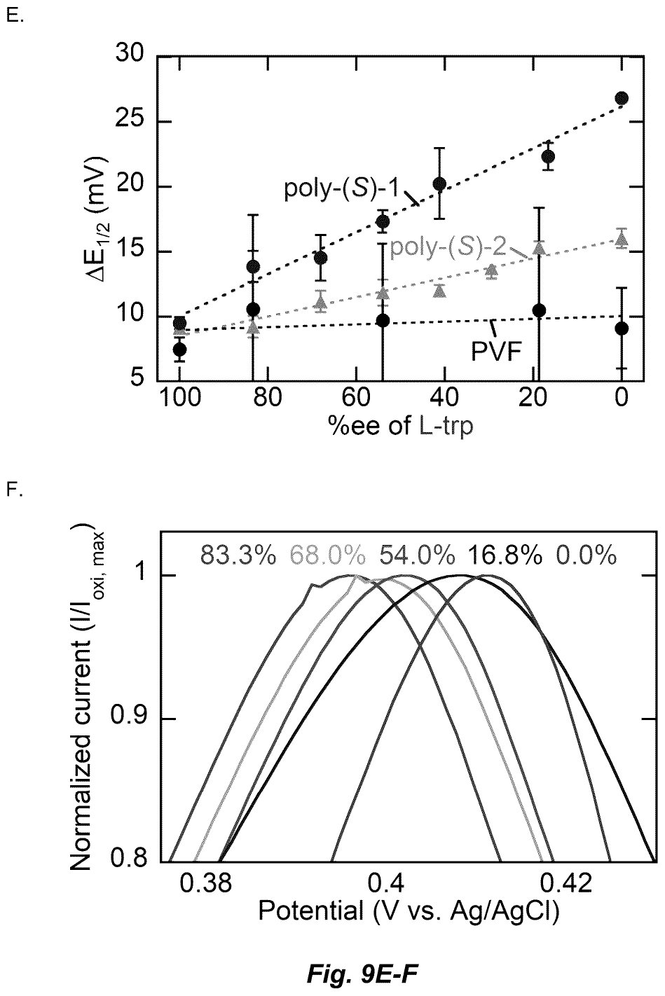

Both the polymers showed measurable enantioselective recognition toward naproxen as well as tryptophan (FIG. 9). Poly-(S)-1 had a higher potential shift difference than poly-(S)-2 over the entire concentration range (FIGS. 9A and 9C). The best fitting for ΔE_{1/2} of the polymers with tryptophan was found with Type 1 Langmuir isotherm and the adsorption equilibrium constants (K) and maximum half potential shifts (ΔE_{1/2, m}) were calculated based on the fittings (Table 1). For D-tryptophan, both ΔE_{1/2, m} and K_{D} of poly-(S)-1 (27.4 mV and 0.2264 L/mmol) were higher than those of poly-(S)-2 (23.64 mV and 0.1198 L/mmol) because COO⁻ and NH₃⁺ of tryptophan could coordinatively form HBs with the amide moieties in poly-(S)-1. A similar dimerization between two amides by forming two HBs was also reported in literature (J. Amer. Chem. Soc. 1974, 96, 3794). In contrast, poly-(S)-2 can form only one electrostatic interaction between COO⁻ and the amine of poly-(S)-2.

For L-tryptophan, one of the HBs with poly-(S)-1 was sterically hindered, leading to its low K_{L} (0.1465 L/mmol) whereas poly-(S)-2 had a higher K_{L} (0.2504 L/mmol) owing to the stronger electrostatic interaction. The Gibbs free energy changes of the adsorption were also calculated based on the equilibrium constants K_{L} and K_{D} (Table S9). ΔΔG of poly-(S)-1 and poly-(S)-2 were 1.07 and 1.82 kJ/mol, respectively, which are in the same order of magnitude with π-π interaction, dipole-dipole, and hydrogen bonding. In short, the enantioselectivity toward tryptophan was higher with poly-(S)-1 than poly-(S)-2 because of the stereospecific interaction by the amide of poly-(S)-1.

TABLE 1
Adsorption equilibrium constant K and maximum half potential
shift (ΔE_{1/2, m}) of poly-(S)-1 and poly-(S)-2 with trp
enantiomers from Langmuir isotherm-analogous equation.*

| | Poly-(S)-1 | | Poly-(S)-2 | |
|---|---|---|---|---|
| | L-trp | D-trp | L-trp | D-trp |
| K (L/mmol) | 0.1465 | 0.2264 | 0.2504 | 0.1198 |
| ΔE_{1/2, m} (mV) | 10.95 | 27.40 | 9.50 | 23.64 |
| ΔG (kJ/mol) | −12.36 | −13.43 | −13.68 | −11.86 |

*Adsorption equilibrium constant K and maximum half potential shift remain similar regardless of the scan rates.

With 2 mM naproxen, |ΔΔE_{1/2}| was 7.3 mV and 5.9 mV for poly-(S)-1 and poly-(S)-2, respectively, with (S)-naproxen giving the higher peak shifts than (R) for both polymers (FIGS. 9B and 9D). The higher potential shift difference of poly-(S)-1 than poly-(S)-2 was presumably due to the π-π interaction of the Fc and naphthyl group balanced by the HB between COO⁻ and the amide. On the other hand, the electrostatic interaction of poly-(S)-2 could likely outweigh other interactions and impeded a stereospecific binding despite higher K_{Nap} than that of poly-(S)-1. In summary, poly-(S)-1 had the higher |ΔΔE_{1/2}| with the tested analytes than poly-(S)-2 although poly-(S)-2 had the higher ΔE_{1/2} with the anionic chiral analyte, naproxen.

Analyte-% ee-dependent Potential Shift of the Chiral Redox-metallopolymers. The half potential shift of the polymers with different % ee at a fixed concentration of tryptophan was measured to evaluate the potential application of the polymers for electrochemical enantioselective sensing (FIG. 9E). Importantly, a linear dependence of the half potential shift on % ee was observed for both polymers over a wide range of 0-100% ee L-tryptophan. The slope of the shift (ΔE_{1/2}) of poly-(S)-1 (0.162 mV/% ee with R²=0.98) was steeper than poly-(S)-2 (0.075 mV/% ee with R²=0.95) over this range owing to the higher enantioselectivity of poly-(S)-1 than poly-(S)-2. FIG. 9F shows oxidation peak potentials of poly-(S)-1 at various % ee of L-tryptophan and the potential shift to a higher potential. In contrast, the potential shift of polyvinyl ferrocene (PVF), a polymer with an achiral Fc moiety, stayed the same (0.011 mV/% ee with R²=0.12) over the % ee range (FIG. 9E). This result demonstrated the simple insertion of the chirality between the Fc and the vinyl backbone can impart enantioselectivity over an atomically non-chiral backbone, which then can be potentially used as an electrochemical sensor for enantiomers. Future studies are envisioned to focus on enhancing resolution.

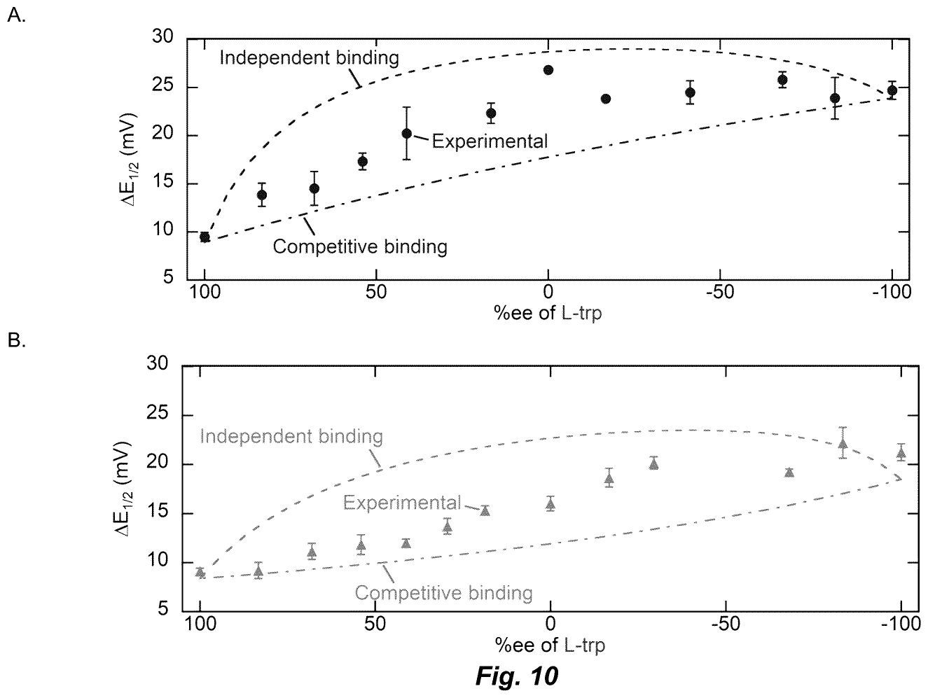

Interestingly, the ΔE_{1/2} of both polymers had little to no change over the range of 0-100% ee D-tryptophan (FIG. 10). The comparison between the experimental and theoretical ΔE_{1/2} using the calculated adsorption equilibrium constants revealed that the adsorption of L- and D-tryptophan onto the binding sites of the polymers is not entirely competitive. There are possible interactions between L- and D-tryptophan on adjacent sites, or possibly additional tryptophan binding to a polarized tryptophan that is already bound to a binding site. As previously reported in literature, the tryptophan binding strength differs among L- and L-tryptophan, D- and D-tryptophan, and L- and D-tryptophan because of their zwitterionic property, and L- and D-tryptophan form the most stable binding, thus leading to the higher potential shift of the polymers than with the assumption of the competitive binding between the enantiomers,

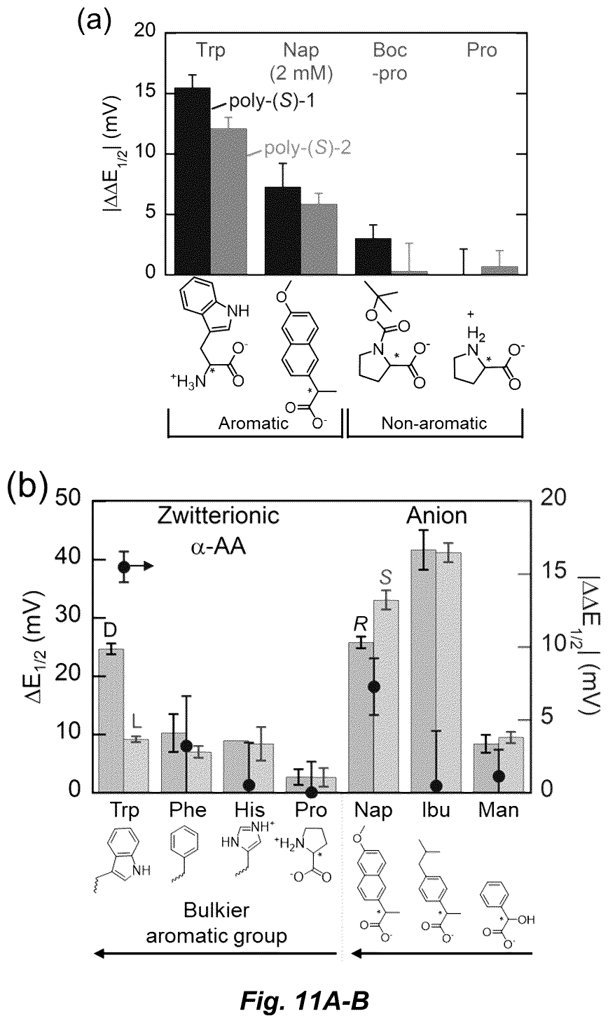

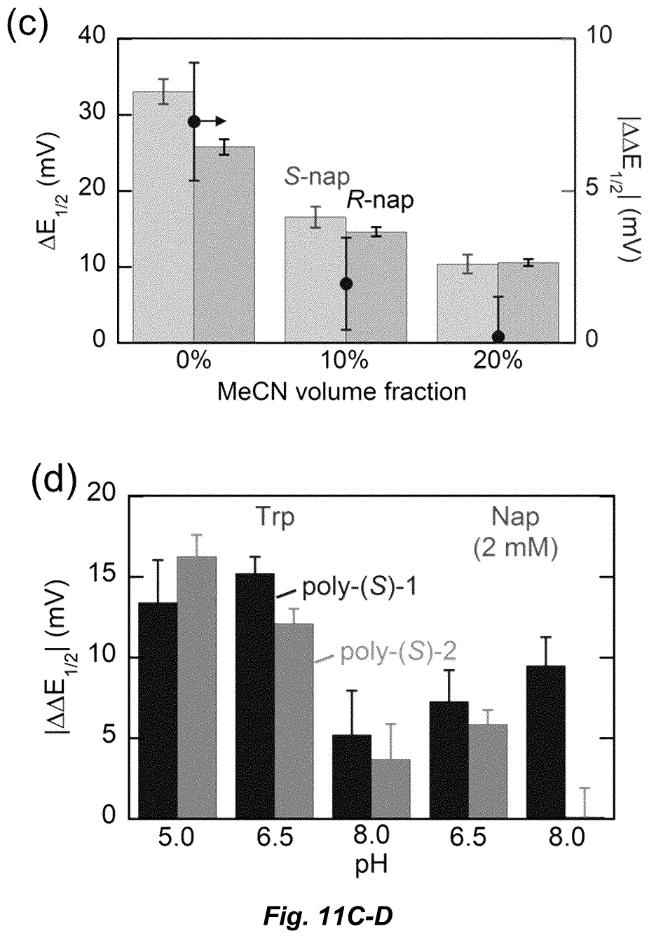

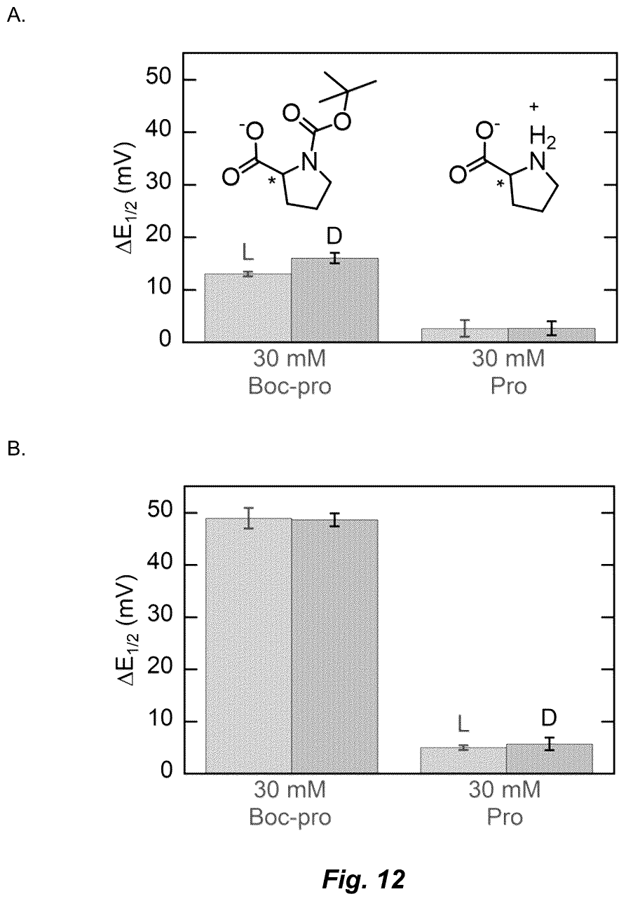

Enantioselective recognition mechanism of the chiral redox-metallopolymers. We investigated the effect of the solvent polarity and solution pH, as well as the selectivity mechanism of poly-(S)-1 and poly-(S)-2 by using a series of representative enantiomers. The magnitude of the half potential shift difference (|ΔΔE_{1/2}|) of poly-(S)-1 and poly-(S)-2 with tryptophan, naproxen, Boc-proline, and proline had a strong correlation with the presence or absence of an aromatic group in an analyte, regardless of its net charge (FIG. 11A). Tryptophan showed a noticeable potential difference due to its indole group (15.5 and 12.1 mV for poly-(S)-1 and poly-(S)-2, respectively). Especially, the |ΔΔE_{1/2}| of 2 mM naproxen (7.3 and 5.9 mV for poly-(S)-1 and poly-(S)-2) was significantly higher than the other analytes (30 mM) due to its naphthyl group, the bulkiest aromatic group among the aromatic groups of the analytes. However, in each 30 mM enantiopure Boc-proline and proline, only poly-(S)-1 and Boc-proline showed a shift difference (3.0 mV) (FIG. 12). This dependency suggests the importance of the steric effect of an aromatic group and its π-π interaction (π-π) with the Fc of the polymers for the enantioselective recognition. FIG. 11B shows the half potential shift of poly-(S)-1 with zwitterionic α-amino acids and carboxylates with an aromatic group. An analyte with a bigger aromatic group generally led to a higher ΔE_{1/2} and |ΔΔE_{1/2}| of poly-(S)-1 regardless of the charge of an analyte. Tryptophan showed a higher |ΔΔE_{1/2}| and ΔE_{1/2} than those of phenylalanine and histidine, whereas proline showed a negligible ΔE_{1/2} (2.7 mV) and 0 mV of |ΔΔE_{1/2}|. Among the carboxylates, naproxen showed the highest ΔΔE_{1/2} (7.3 mV). The selectivity dependency on the size of an aromatic group suggested that a bulkier aromatic group led to more steric hindrance for a stereospecific interaction as well as π-π coordinating with HBs.

We next studied the effect of solvent polarity through the addition of MeCN, and the effect of pH through pH adjustment to investigate the strength change of the involved interactions (i.e., π-π and HB). First, for the solvent polarity experiments, the |ΔΔE_{1/2}| of poly-(S)-1 with naproxen dropped from 7.3 mV to 2.0 mV with 10% MeCN and to 0.2 mV with 20% MeCN (FIG. 11C). A less polar and aprotic environment generally leads to an increase in the strength of HB and a decrease in the strength of π-π between an adsorbate and adsorbent. ΔE_{1/2} also decreased because weaker π-π between the naphthyl group and the Fc resulted in a lower K_{Nap} than in 0% MeCN. Also, the peak shift of (S)-1 and (S)-2 dissolved in dry MeCN showed little to no |ΔΔE_{1/2}| (within the confidence limit) for deprotonated naproxen, Boc-proline, and Boc-tryptophan enantiomers at various concentrations due to the strong HB outweighing other interactions. Hence, it is a key to have a subtle balance among the strengths of interactions between a chiral host and guest for high enantioselectivity in redox-mediated electrochemical recognition, in alignment with previous enantioselective recognition studies (J. Amer. Chem. Soc. 2002, 124, 813).

The pH of 1× PBS was varied between 5.0-8.0 to adjust the HB strength (FIG. 11D). With the same enantiomer affinity toward D-tryptophan, |ΔΔE_{1/2}| of poly-(S)-1 dropped both at the acidic and basic pH (13.4 mV at pH 5.0 and 5.2 mV at pH 8.0). The decrease was more significant at the basic pH, where the HB between —NH₃⁺ of tryptophan and the amide —CO of poly-(S)-1 became weaker. This result suggests that the stereospecific interaction accounting for the enantioselectivity of poly-(S)-1 was predominantly due to the HB of the —NH₃⁺ of tryptophan and —CO of poly-(S)-1. On the other hand, the selectivity of poly-(S)-1 toward naproxen anions did not decrease at pH 8.0, because of the maintained balance between π-π and HB of —COO⁻ and amide NH, as well as the absence of NH₃⁺. The selectivity of poly-(S)-2 for both tryptophan and naproxen declined at the higher pH due to the decreasing strength of the electrostatic interaction between —COO⁻ and —NH⁺, which was outcompeted by π-π as the pH became basic. Such pH-dependent strength of electrostatic interaction between —COO⁻ and NH⁺ have been seen in biological macromolecules previously (J. Amer. Chem. Soc. 2015, 137, 5730). Overall, our results suggest a balance of interactions depending on the structural motifs of the redox-receptor and target analyte identity, with hydrogen bonding and π-π playing a key role in determining enantioselectivity.

Conclusion. In this work, we have designed and synthesized chiral redox-metallopolymers, based on chiral Fc monomers as building blocks, poly-1 with amide-functionalized ferrocene and poly-2 with amine-functionalized ferrocene for heterogeneous enantioselective recognition. The chiral redox-electrodes were investigated for enantioselective potential-shift-based binding towards a range of enantiomers of amino acids and carboxylates. Especially, we found out that the chiral Fc unit not only enabled enantioselective electrochemical sensing, but also induced supramolecular chirality effects observed by both CD and the resulting enhancement of recognition. The chiral redox-polymers presented significantly higher enantioselective recognition toward tryptophan and naproxen, compared to their corresponding monomers.

The effect of hydrogen bonding, solvent effects, and structural motifs of the enantiomer analytes are evaluated through electrochemical characterization. Our current work provides a new avenue for the design of chiral redox-metallopolymers and their use in electrochemical potential- based enantioselective sensing toward a range of chiral molecules including amino acids, pharmaceuticals, and organic carboxylates.

The following Examples are intended to illustrate the above invention and should not be construed as to narrow its scope. One skilled in the art will readily recognize that the Examples suggest many other ways in which the invention could be practiced. It should be understood that numerous variations and modifications may be made while remaining within the scope of the invention.

### EXAMPLES

### Example 1. Product Characterization

HPLC. Separation between (S) and (R) enantiomers of 1-ferrocenyl-ethylamine and N-methyl-1-ferrocenyl-ethylamine by diastereomeric crystallization was quantified by a reversed-phase high pressure liquid chromatography (RP-HPLC) (Agilent 1260 Infinity II, Agilent Technologies, USA; coupled with 1260 Infinity II Variable Wavelength Detector). An Agilent Infinity Lab Poroshell 120 Chiral-V column (4.6×150 mm, 2.7 μm particle size) was used to separate the enantiomers sampled from the crystals with an isocratic mobile phase of 50 mM NH₄HCOO water at 25° C. and 0.5 mL/min. The injection volume of the samples prepared by dissolving 10 mg of the crystals in 1 mL of the mobile phase was 5 μL. The retention time detected at 250 nm was 7.8 and 8.9 mM for (R)- and (S)-1-ferrocenyl-ethylamine 9.0 and 10.0 min for (R)- and (S)-N-methyl-l-ferrocenyl-ethylamine, respectively.

Single-crystal X-ray diffraction. (S)-N-(1-ferrocenylethyl)methacrylamide and (+)-tartrate salt of (S)-N-methyl-1-ferrocenyl-ethylamine were dissolved and saturated in methanol at 55° C. Single crystals were grown as the solvent was slowly dried at RT for 3 days. D8 Kappa APEXII (Bruker, USA) was used for X-ray diffraction measurement.

NMR. The nuclear magnetic resonance (NMR) spectra were obtained using Varian Unity INOVA 500NB (500 MHz; 5 mm Varian 1H{13C/15N} PFG Z probe) (Varian, USA) and analyzed in the software MestReNova V.14.1.0.

Flash chromatography. C-810 Pure Flash Chromatography System (BÜCHI Corporation, USA) was used to purify synthesis products.

ESI-MS. High-resolution Electronspray Ionization mass spectrometry (ESI-MS) was obtained by Waters Q-TOF Ultima ESI equipped with a reflection time-of-flight (TOF) analyzer.

GPC. Gel permeation chromatography (GPC) was performed using a Tosoh Ecosec HLC-8320GPC (Tosoh, Japan) at 40° C. fitted with two analytical columns (7.8 mm ID×30 cm×5 μm). The reference flow rate was 1 mL/min while the analytical column was at 1.0 mL/min. For poly-(S), (R)-1, THF (HPLC grade) was used as the eluent and polystyrene standards (15 points ranging from 500 Mw to 8.42 million Mw) were used as the general calibration. For poly-(S), (R)-2, LiBr DMF (HPLC grade) was used as the eluent and poly(methyl methacrylate) standards were used for the calibration with the flow rate of 0.6 mL/min.

Circular dichroism. All solution CD spectra were obtained with Olis Cary-16 Spectrophotometer coupled with Circular Dichroism Module (Olis, Inc., USA) under N2 purging at 20° C. using a 1 mm-path-length quartz cuvette sample holder (Azzota Corporation, USA) was used. All solid-state CD spectra were obtained by using J-1500 Circular Dichroism Spectrophotometer (Jasco, USA) under N2 purging at RT. The monomers and polymers were deposited on a quartz window (Hellma, USA) by drop-casting 0.1 mL of the solutions in CHCl3 used for the electrode deposition (1.0 mg/mL for (S)-1 and poly-(S)-1 and 1.19 mg/mL for (S)-2 and poly-(S)-2). The anisotropic background of the solid-state CD spectra was removed by running the samples on both sides of the quartz window and averaging those two CD spectra.

UV-Vis spectroscopy. Cary 60 UV-Vis (Agilent Technologies, USA) was used to obtain UV-Vis spectra. For the solid-state measurement, the UV-Vis spectra were obtained along with CD spectra.

SEM. The surface morphologies and elemental mapping images of the electrodes were obtained using a scanning electron microscope (SEM; Hitachi S-4700) operated at an accelerating voltage of 10 kV, equipped with energy dispersive X-ray spectroscopy (EDS; iXRF) with the accelerating voltage of 15 kV.

Voltammetry. BioLogic SP 200 (BioLogic, USA) was used in all electrochemical experiments.

Confocal laser scanning microscopy. Keyence VK-X1000 3D Laser Scanning Confocal Microscope (Keyence, Japan) was used to obtain optical microscope images and confocal laser scanning microscopy images of a polymer film.

Surface profilometry. Sloan Dektak3 ST Profilometer was used to obtain the thickness profile of a polymer film. The stylus force was 15 mg with Low Speed and High Data Resolution mode.

Electrode fabrication with the optimization of coating concentration and incubation time. Chiral electrodes used for heterogeneous sensing were prepared by drop-casting 8 μL of a coating material solution in chloroform on a GCE which was polished with alumina dispersion on a micro-cloth. The coating concentration of poly-(S)-1 and poly-(S)-2 was varied to select a thickness of the polymer deposition (FIGS. 3A-B). 1.0 mg/mL of poly-(S)-1 and 1.19 mg/mL of poly-(S)-2 were chosen in the coating concentration range where the peak current was linear to the coating concentration as the peak current is linear to the surface coverage of a redox species adsorbed on an electrode. The incubation time in a chiral analyte solution was varied to find the minimum time for the binding equilibrium under stirring at 600 RPM. The indicator for the binding equilibrium was a half potential shift. 8 min of the incubation time was chosen for the incubation time as the half potential peak shift of both poly-1 and poly-2 reached its maximum value after 4 and 8 min, respectively (FIGS. 3C-D).

Thickness of the polymer film. The poly-(S)-1 film uniformity and thickness were investigated by confocal laser scanning microscopy (CLSM) and contact profilometry. A poly-(S)-1 film was prepared by drop-casting a proportional volume (22.2 μL) of the polymer solution in chloroform onto a glassy carbon (GC) substrate of 10 mm diameter. The optical microscope image showed the non-uniform surface of the film. We scraped off the edge of the film to measure the film thickness near the edge. The step height from the confocal laser scanning microscopy image and the profilometer measurement had an agreement that the thickness was about 60 nm near the edge of the film while the film thickness at the center of the substrate was 186 nm based on the profilometer measurement.

Half potential shift in homogeneous electrolyte. For homogeneous recognition tests, dry acetonitrile (MeCN) was used to provide an aprotic environment and thus minimize HB interaction with analytes. Carboxylic acids were deprotonated with an oxidizer, tetrabutylammonium hydroxide (TBAOH). The free amino acids (i.e., Trp and Pro) were not used due to their instability in pure MeCN. Analyte titration in the presence of (S)-1 or (S)-2 showed considerable negative peak shifts. For example, 400 molar equivalents of Boc-Pro shifted the half potential of (S)-1 and (5)-2 by −89.7 and −46.2 mV respectively. The control test with TBAOH titration had a negligible peak shift, suggesting the half potential change was not due to the pH change. However, there was little to no discrimination between the enantiomers of naproxen, Boc-Trp, and Boc-Pro with both (S)-1 and (S)-2.

### Example 2. Synthesis of Intermediates, Monomers and Polymers

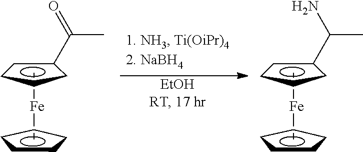

1-Ferrocenyl-ethylamine. Acetylferrocene (20 g, 1 Eq, 88 mmol) and titanium isopropoxide (50 g, 52 mL, 2 Eq, 0.18 mol) were dissolved in Ethanol (100 mL) in a 2-neck flask with a reflux condenser and drying tube. Ammonia in methanol (7.5 g, 63 mL, 7 molar, 5 Eq, 0.44 mol) was added and the mixture was stirred for 16 hr at RT. Thin layer chromatography (TLC) with Hexane:Ethyl acetate (7:3 v/v) showed no visible educt after 17 hr. The mixture was cooled in an ice bath. Sodium borohydride (5.0 g, 1.5 Eq, 0.13 mol) was added in 5 portions with 15 min stirring between the additions. The mixture stirred for an additional 3 h at RT. The reaction mixture is poured into 2M NH₄OH solution (120 ml) and the titanium oxide was precipitated.

The solution was filtered using Whatman 2V Folded Filter (GE Healthcare, USA), and the product was extracted with diethyl ether. The combined organic phases were extracted with 1M HCl and the combined acidic aqueous phases were washed with diethyl ether. The aqueous phase was basified by adding solid NaOH and again extracted with Ether. The combined organic phases were washed with brine and dried with MgSO₄, and then the solvent was dried. Yield: 16.04 g, 80%, red oily liquid. ¹H NMR (500 MHz, CDCl₃): δ 4.18-4.14 (m, 9H, Fc), 3.82 (q, J=6.5 Hz, 1H, CH), 1.37 (d, J=6.5 Hz, 3H, CH₃). HR-ESI-MS m/z: [M]⁺ calculated for C₁₂H₁₅FeN, 229.0554; found, 229.0546. CHN analysis calculated for C₁₂H₁₅FeN: C, 62.91; H, 6.6; N, 6.11; found, C, 62.32; H, 6.39; N, 5.96.

Two different Ugi's amine derived monomers containing an amide or amine group at the same position of the amine of Ugi's amine were synthesized. The racemates were separated by diastereomeric crystallization with enantiopure tartaric acid, followed by the addition of methacrylate derivatives to yield N-(1-ferrocenylethyl) methacrylamide (M) and 2-((1-ferrocenylethyl)(methyl)amino)ethyl methacrylate (A). The enantiomeric excesses of the precursors to each monomer were 96.4%, 93.4%. 94.7%, and 96.1% for R-M, S-M, R-A, and S-A, respectively according to the high-pressure liquid chromatography (HPLC).

Various techniques were used to confirm the structure and determine chirality and electrochemical characteristics of the synthesized Ugi's amine analogues. Single-crystal X-ray diffraction (XRD) on S-A precursor and S-M revealed their absolute chirality from the crystal structures. Interestingly, it was the R-M precursor that dominantly formed crystals with (+)-tartaric acid while the R-A precursor had stronger ionic bonding with (−)-tartaric acid under the same condition. Circular dichroism (CD) showed the opposite chirality of S and R monomers. The Cotton effects in the two absorption spectra in π-π* (250 nm) and π-π (450 nm) are attributed mainly to the Fc metallocene. The similarity between the CD of the monomers and polymers with the same chirality implies their optical activity is mainly from the point chirality. CV showed their one-electron transfer reaction of the ferrocene unit and relative electron densities of the monomers near the Fc unit. The half potential of the monomer A is noticeably smaller than that of Ugi's amine implying a more electron-rich nature.

Chiral resolution of 1-ferrocenyl-ethylamine. A solution of racemic 1-Ferrocenyl ethylamine in methanol was added to a solution of equimolar (+)-tartaric acid in methanol at 55° C. The solution stood at room temperature for 24 h, giving the (+)-tartrate salt of (R)-1-Ferrocenyl ethylamine. After multiple cycles of crystallization and recrystallization using methanol, the (+)-tartrate salt of (R)-1-Ferrocenyl ethylamine with 96.4% ee was yielded based on the HPLC. The raffinates from each crystallization were combined into one solution and (S)-enriched 1-ferrocenyl-ethylamine in the solution was separated from (+)-tartaric acid by adding 1M NaOH into the combined raffinate solution and extracting 1-ferrocenyl-ethylamine by dichloromethane (DCM). The combined organic phases were washed with brine and dried with MgSO₄, and then the solvent was dried. A solution of (S)-enriched 1-Ferrocenyl ethylamine in methanol was added to a solution of equimolar (−)-tartaric acid in methanol at 55° C. The solution stood at room temperature for 24 h, giving the (−)-tartrate salt of (S)-1-Ferrocenyl ethylamine. After multiple cycles of crystallization and recrystallization using methanol, the (−)-tartrate salt of (S)-1-Ferrocenyl ethylamine with 93.4% ee was yielded based on the HPLC. 1-Ferrocenyl ethylamine was separated from tartrate by dissolving the salts in 1M NaOH and extracting 1-Ferrocenyl ethylamine into DCM. The organic phase was further dried with a brine and then Na₂CO₃ before the addition of methacryloyl chloride.

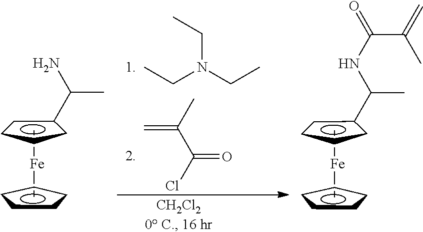

(S)-1 and (R)-1. (S)-1-Ferrocenyl ethylamine (5.00 g, 1 Eq, 21.8 mmol) was dissolved in dry DCM (50 mL). Triethylamine (4.42 g, 6.08 mL, 2 Eq, 43.6 mmol) was added with a syringe. The orange solution was then cooled with an ice bath before the methacryloyl chloride (3.42 g, 3.20 mL, 1.5 Eq, 32.7 mmol) was added. The solution was stirred in the ice bath and slowly warmed to RT and stirred for 16 hr. TLC with Hexane:EtOAc (7:3 v/v) showed no visible educt. The solution was washed consecutively with 1M NaOH solution (50 mL), water (50 mL), and brine (50 mL). Afterward, the organic phase was dried with MgSO₄ and the solvent was evaporated after filtration. The solvent was removed, yielding the crude product as an orange solid (7.12 g). The product was purified by flash chromatography (Hexane/EtOAc gradient, 80 g Ecoflex Silica, dry load). Yield: 4.59 g, 70.8%, orange solid. ¹H NMR (500 MHz, CDCl₃): δ 6.06 (s, 1H, NH), 5.73-5.35 (s, 2H, ═CH₂), 4.91 (quint, J=8.5 Hz, 1H, CH), 4.25-4.10 (m, 9H, Fc), 2.00 (s, 3H, ═C—CH₃), 1.48 (d, J=8.5 Hz, 3H, —CH₃). HR-ESI-MS m/z: [M]⁺ calculated for C₁₆H₁₉FeNO, 297.0816; found, 297.0804. CHN analysis calculated for C₁₆H₁₉FeNO: C, 64.67; H, 6.44; N, 4.71; found, C, 64.72; H, 6.4; N, 4.7. Single crystal XRD of (S)—N-(1-ferrocenylethyl)methacrylamide ((S)-1) obtained.

(R)-1-Ferrocenyl ethylamine (1.56 g, 1 Eq, 6.81 mmol) was dissolved in dry DCM (50 mL). Triethylamine (1.38 g, 1.90 mL, 2 Eq, 13.6 mmol) was added by syringe. The orange solution was then cooled with an ice bath before the methacryloyl chloride (1.07 g, 1.00 mL, 1.5 Eq, 10.2 mmol) was added. The solution was stirred in the ice bath and slowly warmed to RT and stirred for 16 hr. TLC with Hexane:EtOAc (7:3 v/v) showed no visible educt. The solution was washed consecutively with 1M NaOH solution (20 mL), water (20 mL), and brine (20 mL). Afterward, the organic phase was dried with MgSO₄ and the solvent was evaporated after filtration. The solvent was removed, yielding the crude product as an orange solid (3.70 g). The product was purified by flash chromatography (Hexane/EtOAc gradient, 25 g Ecoflex Silica, dry load). Yield: 1.63 g, 80.7%, orange solid. ¹H NMR (500 MHz, CDCl₃): δ 6.06 (s, 1H, NH), 5.73-5.35 (s, 2H, ═CH₂), 4.91 (quint, J=8.5 Hz, 1H, CH), 4.25-4.10 (m, 9H, Fc), 2.00 (s, 3H, ═C—CH₃), 1.48 (d, J=8.5 Hz, 3H, —CH₃). HR-ESI-MS m/z: [M]⁺ calculated for C₁₆H₁₉FeNO, 297.0816; found, 297.0816. CHN analysis calculated for C₁₆H₁₉FeNO: C, 64.67; H, 6.44; N, 4.71; found, C, 64.60; H, 6.30; N, 4.82.

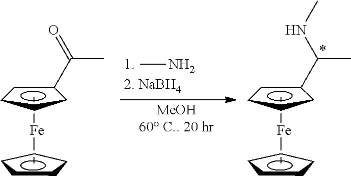

N-methyl-1-ferrocenyl-ethylamine. Acetylferrocene (60.0 g, 1 Eq, 263 mmol) was added to 1 L flask and dissolved in dry methanol (200 mL) with molecular sieve 3 Å (45 g). Methylamine (62 g, 2.5 Eq, 658 mmol) was added to the solution. The mixture was stirred for 20 h at 60° C. with a reflux. TLC with DCM:methanol (95:5 v/v) showed no visible educt. The reaction mixture was cooled in an ice bath and then sodium borohydride (20.0 g, 2 Eq, 530 mmol) was added in 5 portions. The mixture was stirred overnight. The mixture was filtered through a pad of celite and the solvent was evaporated. The organic phases were extracted with 1M HCl and the combined acidic aqueous phases were washed with ether. The aqueous phase was basified by adding solid NaOH and extracted with ether. The organic phases were washed with brine and dried with Na₂CO₃ and then the solvent was dried. Yield: 51.38 g, 80.3%, red oily liquid. ¹H NMR (500 MHz, CDCl₃): δ 4.17-4.11 (m, 9H, Fc), 3.42 (q, J=6.45, 1H, CH), 2.41 (s, 3H, N—CH₃), 1.37 (d, J=6.45, 3H, C—CH₃). HR-ESI-MS m/z: [M]⁺ calculated for C₁₃H₁₇FeN, 242.0632; found, 242.0640. CHN analysis calculated for C₁₃H₁₇FeN: C, 64.22; H, 7.05; N, 5.76; found, C, 63.88; H, 7.00; N, 5.86.

Chiral resolution of N-methyl-1-ferrocenyl-ethylamine. A solution of racemic N-methyl-1-ferrocenyl-ethylamine in methanol was added to a solution of equimolar (+)-tartaric acid in methanol at 55° C. The solution stood at room temperature for 24 h, giving the (+)-tartrate salt of (5)-N-methyl-1-ferrocenyl-ethylamine. After multiple cycles of crystallization and recrystallization using methanol, the (+)-tartrate salt of (S)-N-methyl-1-ferrocenyl-ethylamine with 96.1% ee was yielded based on the HPLC. The raffinate from the first crystallization, (R)-enriched N-methyl-1-ferrocenyl-ethylamine in methanol, was separated from (+)-tartaric acid by drying methanol, adding water and solid NaOH to the dried raffinate in an ice bath. The red oily product phase was formed on the top of the basic aqueous solution. Ether was added to the mixture to further extract the (R)-enriched N-methyl-1-ferrocenyl-ethylamine. The organic phases were washed with brine and dried with Na₂CO₃. The solvent was dried. A solution of (R)-enriched N-methyl-1-ferrocenyl ethylamine in methanol was added to a solution of equimolar (−)-tartaric acid in methanol at 55° C. The solution stood at room temperature for 24 h, giving the (−)-tartrate salt of (R)-enriched N-methyl-1-Ferrocenyl ethylamine. After multiple cycles of crystallization and recrystallization using methanol, the (−)-tartrate salt of (R)-N-methyl-1-Ferrocenyl ethylamine with 94.7% ee was yielded based on the HPLC. Both (S)- and (R)-N-methyl-1-Ferrocenyl ethylamine after the chiral resolution by crystallization were separated from (+)- and (−)-tartaric acid, respectively, by drying methanol, adding water and solid NaOH to the dried tartrate salt of N-methyl-1-Ferrocenyl ethylamine in an ice bath. Ether was added to the solution to extract N-methyl-1-ferrocenyl-ethylamine. The organic phases were washed with brine and dried with Na₂CO₃, and then the solvent was dried. Single crystal XRD of (+)-tartrate salt of (S)-N-methyl-1-ferrocenyl-ethylamine obtained.

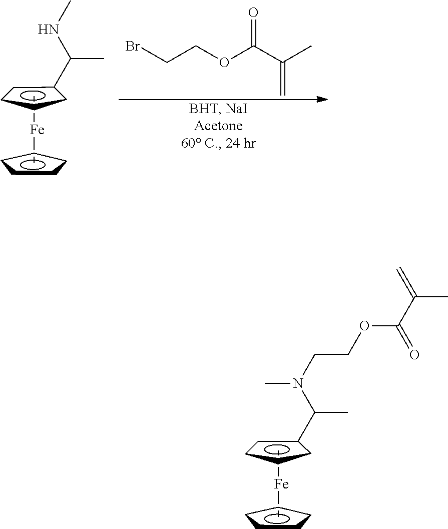

(S)-2 and (R)-2. (S)-N-methyl-1-ferrocenyl-ethylamine (14.7 g, 1 Eq, 60.5 mmol), 2-bromoethyl methacrylate (17.5 g, 1.5 Eq, 90.7 mmol), sodium iodide (15.9 g, 1.75 Eq, 106 mmol), and 2,6-di-tert-butyl-4-methylphenol (BHT) (133 mg, 0.01 Eq, 605 μmop were dissolved in dry acetone (220 mL). The mixture was stirred for 24 h at 60° C. A salt of NaBr was precipitated shortly after mixing the chemicals. TLC with Hexane:EtOAc (6:4 v/v) showed no visible educt. The solution was decanted, filtered, and evaporated. (S)-N-methyl-1-ferrocenyl-ethylamine was purified by removing insoluble salts in ether. 1M HCl was added to the solution and (S)-N-methyl-1-ferrocenyl-ethylamine was extracted to the acidic aqueous phase. The acidic aqueous phase was washed with ether and then basified with solid NaOH. (S)-N-methyl-1-ferrocenyl-ethylamine was extracted with ether. The organic phase was washed with brine and dried with Na₂CO₃. The solvent was evaporated, yielding the red oily product. The product was purified by flash chromatography (Hexane/EtOAc gradient, 80 g Ecoflex Silica, liquid load). Yield: 5.26 g, 24.5%, red oily liquid. ¹H NMR (500 MHz, CDCl₃): δ 6.09-5.55 (s, 2H, ═CH₂), 4.21-4.11 (m, 9H, Fc), 4.15 (t, J=7.5 Hz, 2H, N—CH₂—C), 3.76 (q, J=6.2 Hz, 1H, N—CH-Fc), 2.60-2.45 (m, J=7.5 and 77.8 Hz, 2H, C—CH₂—O). HR-ESI-MS m/z: [M]⁺ calculated for C₁₉H₂₅FeNO₂, 356.1313; found, 356.1305. CHN analysis calculated for C₁₉H₂₅FeNO₂: C, 64.24; H, 7.09; N, 3.94; found, C, 64.04; H, 7.06; N, 3.84.

(R)-N-methyl-1-ferrocenyl-ethylamine (11.4 g, 1 Eq, 46.9 mmol), 2-bromoethyl methacrylate (13.6 g, 1.5 Eq, 70.4 mmol), sodium iodide (12.3 g, 1.75 Eq, 82.1 mmol), and 2,6-di-tert-butyl-4-methylphenol (BHT) (103 mg, 0.01 Eq, 469 μmol) were dissolved in dry acetone (220 mL). The mixture was stirred for 24 h at 60° C. A salt of NaBr was precipitated shortly after mixing the chemicals. TLC with Hexane:EtOAc (6:4 v/v) showed no visible educt. The solution was decanted, filtered, and evaporated. (S)-N-methyl-1-ferrocenyl-ethylamine was purified by removing insoluble salts in ether. 1M HCl was added to the solution and (S)-N-methyl-1-ferrocenyl-ethylamine was extracted to the acidic aqueous phase. The acidic aqueous phase was washed with ether and then basified with solid NaOH. (S)-N-methyl-1-ferrocenyl-ethylamine was extracted with ether. The organic phase was washed with brine and dried with Na₂CO₃. The solvent was evaporated, yielding the red oily product. The product was purified by flash chromatography (Hexane/EtOAc gradient, 80 g Ecoflex Silica, liquid load). Yield: 8.48 g, 50.9%, red oily liquid. ¹H NMR (500 MHz, CDCl₃): δ 6.09-5.55 (s, 2H, ═CH₂), 4.20-4.11 (m, 9H, Fc), 4.15 (t, J=6.2 Hz, 2H, N—CH₂—C), 3.76 (q, J=6.5 Hz, 1H, N—CH-Fc), 2.60-2.45 (m, J=7.0 and 77.7 Hz, 2H, C—CH₂—O). HR-ESI-MS m/z: [M]⁺ calculated for C₁₉H₂₅FeNO₂, 356.1313; found, 356.1297. CHN analysis calculated for C₁₉H₂₅FeNO₂: C, 64.67; H, 6.44; N, 4.71; found, C, 64.60; H, 6.30; N, 4.82.

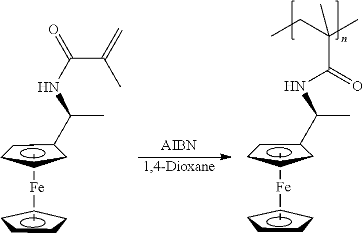

Poly-(S)-1 and poly-(R)-1. (5)-1 (2.40 g, 1 Eq, 8.08 mmol) and azobisisobutyronitrile (AIBN) (13.3 mg, 0.01 Eq, 80.8 nmol) were dissolved in 1,4-dioxane (12.5 mL). The mixture was degassed by purging with N₂ for 30 min and heated to 60° C. for 20 hr. Poly-(R)-1 was precipitated in methanol. The solution was decanted and centrifuged. The residual solvent was evaporated. Yield: 1.32 g, 55.0%, yellow powder. ¹H NMR (500 MHz, CDCl₃): δ 6.05-5.74 (br, 1H, NH), 4.64 (br, 1H, CH), 4.15 (br, 9H, Fc), 2.00-1.73 (br, 2H, C—CH₂—C), 1.40 (br, 3H, Fc-C—CH₃), 1.00 (br, 3H, C—C—CH₃). GPC: Mₙ=6172, M_{w}=8649, PDI: 1.40.

(R)-1 (1.40 g, 1 Eq, 4.71 mmol) and AIBN (7.74 mg, 0.01 Eq, 47.11 Nmol) were dissolved in 1,4-dioxane (10 mL). The mixture was degassed by purging with N₂ for 30 min and heated to 60° C. for 20 hr. Poly-(R)-1 was precipitated in methanol. The solution was decanted and centrifuged. The residual solvent was evaporated. Yield: 1.0 g, 71.3%, yellow powder. ¹H NMR (500 MHz, CDCl₃): δ 5.96-5.65 (br, 1H, NH), 4.55 (br, 1H, CH), 4.10 (br, 9H, Fc), 1.62 (br, 2H, C—CH₂—C), 1.33 (br, 3H, Fc-C—CH₃), 0.93 (br, 3H, C—C—CH₃). GPC: Mₙ=14031, M_{w}=26358, PDI: 1.88.

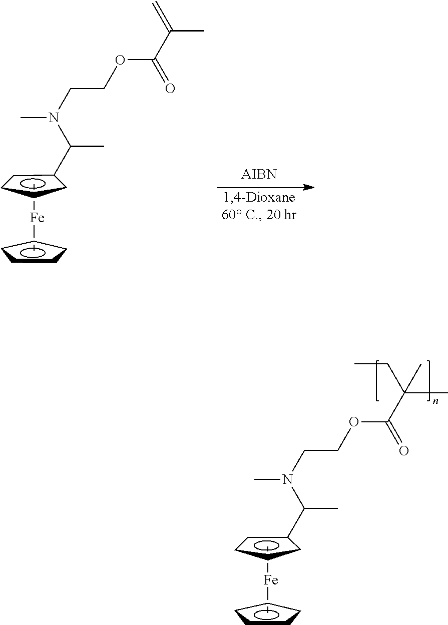

Poly-(S)-2 and poly-(R)-2. (S)-2 (2.16 g, 1 Eq, 6.08 mmol) and AIBN (9.98 mg, 0.01 Eq, 60.8 Nmol) were dissolved in 1,4-dioxane (4.0 mL). The solution was purged with argon and stirred at 60° C. for 20 hr. Acetone was added to the reaction mixture for dialysis using SnakeSkin™ Dialysis Tubing, 3.5 K MWCO, 35 mm dry I.D. (Thermo Scientific™, USA). The acetone in the permeate was changed several times until the permeate solution did not turn yellow. The acetone in the retentate was dried. Yield: 0.12 g, 5.08%, yellow powder. ¹H NMR (500 MHz, CDCl₃): δ 4.15 (br, 9H, Fc), 3.96 (br, 2H, C—CH₂—O), 3.75 (br, 1H, Fc-CH—N), 2.54-2.43 (doublet of broad signal, 2H, N—CH₂—C), 2.11 (br, 3H, N—CH₃), 1.81 (br, 2H, C—CH₂—C), 1.45 (br, 3H, Fc-C—CH₃), 1.04-0.88 (br, 3H, C—C—CH₃). GPC: Mₙ=3555, M_{w}=11406, PDI: 3.21.

(R)-2 (2.26 g, 1 Eq, 6.36 mmol) and AIBN (20.9 mg, 0.02 Eq, 127 μmol) were dissolved in 1,4-dioxane (18 mL). The solution was purged with argon and stirred at 60° C. for 20 hr. Poly-(R)-2 was precipitated in methanol. The solution was decanted and centrifuged. The residual solvent was evaporated. Yield: 1.56 g, 63.6%, yellow powder. ¹H NMR (500 MHz, CDCl₃): δ 4.20-4.16 (br, 9H, Fc), 3.96 (br, 2H, C—CH₂—O), 3.76 (br, 1H, Fc-CH—N), 2.55-2.45 (doublet of broad signal, 2H, N—CH₂—C), 2.12 (br, 3H, N—CH₃), 1.90-1.81 (br, 2H, C—CH₂—C), 1.46 (br, 3H, Fc-C—CH₃), 1.04-0.89 (br, 3H, C—C—CH₃). GPC: Mₙ=14071, M_{w}=20818, PDI: 1.48.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

All publications, patents, and patent documents are incorporated by reference herein, as though individually incorporated by reference. No limitations inconsistent with this disclosure are to be understood therefrom. The invention has been described with reference to various specific and preferred embodiments and techniques. However, it should be understood that many variations and modifications may be made while remaining within the spirit and scope of the invention.

What is claimed is:

1. An optically active polymer comprising repeating units represented by formula I, II or III: 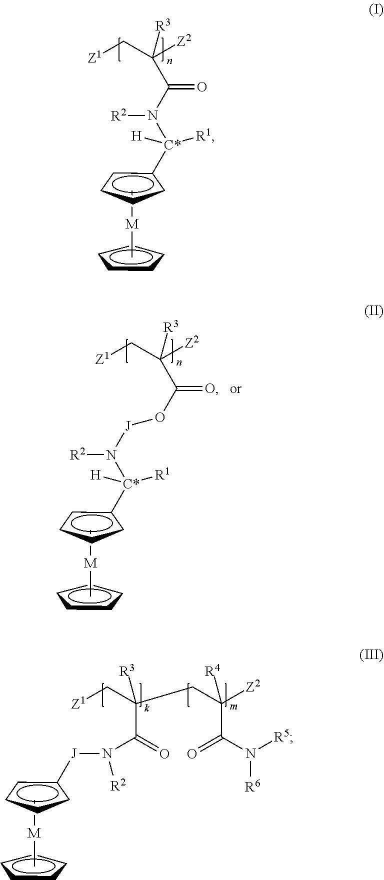
wherein, when present,
C* is a chiral carbon atom having a stereospecific configuration that is the same for at least 90% of the repeating units;
J is —(CH₂)ₓ— wherein x is 2, 3, or 4;
M is a transition metal or transition metal ion;
R¹ is alkyl;
R², R³, R⁴, and R⁵ are each independently H or alkyl;
R⁶ is an optically active moiety wherein the moiety is an amino acid, tertiary polypeptide, saccharide, or antibiotic, and at least 90% of R⁶ are the same optical isomers;
Z¹ and Z² are each independently a terminating group or a polymer block;
k and m are each independently an integer from 1-1000; and
n is an integer from 10 to 1000.

2. The optically active polymer of claim 1 wherein the transition metal is iron or an iron ion.

3. The optically active polymer of claim 1 wherein the optically active polymer comprises poly(N-1-ferrocenyl ethylmethacrylamide).

4. The optically active polymer of claim 1 wherein the optically active polymer comprises 2-((1-ferrocenylethyl)(methyl)amino)ethyl methacrylate.

5. The optically active polymer of claim 1 wherein the optically active polymer is represented by formula I or II and the chiral carbon atom (C*) has an (S)-configuration, or wherein the optically active polymer is represented by formula III and the optical rotation of R⁶ is levorotatory.

6. The optically active polymer of claim 1 wherein the optically active polymer is represented by formula I or II and the chiral carbon atom (C*) has an (R)-configuration, or wherein the optically active polymer is represented by formula III and the optical rotation of R⁶ is dextrorotatory.

7. The optically active polymer of claim 1 wherein the optically active polymer is crosslinked or is a block of a copolymer.

8. A chiral electrode comprising an optically active polymer according to claim 1 wherein the optically active polymer is immobilized on a current collector.

9. The chiral electrode of claim 8 further comprising mesoporous carbon, or a carbon allotrope or carbon nanotube, that is immobilized on the chiral electrode.

10. A chiral electrode comprising:
an optically active polymer, comprising repeating units, immobilized on a current collector, wherein one or more of the repeating units comprise a redox active moiety and an optically active moiety;
wherein at least 90% of all optically active moieties of the optically active polymer are the same optical isomer.

11. The chiral electrode of claim 10 wherein the redox active moiety comprises a metallocene.

12. The chiral electrode of claim 10 wherein the optically active moiety comprises a nitrogen atom covalently bonded directly to a chiral carbon atom, or the optically active moiety comprises an amino acid, tertiary polypeptide, saccharide, or antibiotic.

13. The chiral electrode of claim 10 wherein the repeating unit comprises an acrylate that forms the backbone of the optically active polymer.

14. The chiral electrode of claim 10 wherein the optically active polymer comprises about 10 to about 1000 repeating units.

15. An electrochemical method for sensing or separating and optical isomer, comprising:
a) contacting a solution comprising a mixture of optical isomers and a chiral electrode according to claim 8; and
b) applying a voltage potential to the chiral electrode wherein the voltage potential is applied under suitable conditions for chronoamperometry or voltammetry;
c1) sensing a preferred optical isomer in the mixture via a change in voltage, current, or impedance relative to a reference; and/or
c2) separating from the mixture the preferred optical isomer;
wherein the chiral electrode is the working electrode in an electrochemical cell and an optically active moiety of the optically active polymer selectively binds to the preferred optical isomer in the mixture thereby sensing the preferred optical isomer in the mixture or separating the preferred optical isomer from the mixture.

16. The method of claim 15 wherein the applied voltage potential is sufficient to oxidize or reduce the optically active polymer.

17. The method of claim 15 wherein the applied voltage potential is applied across a voltage range is sufficient to oxidize or reduce the optically active polymer.

18. The method of a claim 15 wherein the solution is a supersaturated mixture of optical isomers.

19. The method of claim 15 further comprising inducing nucleation and crystallization of the preferred optical isomer on the chiral electrode.

20. The method of claim 15 further comprising desorbing the preferred optical isomer to provide a separated optical isomer that is optically active.
